(19) United States
(12) Patent Application Publication
(10) Pub. No.: US 2026/0300799 A1
(43) Pub. Date: Oct. 1, 2026

(54) QUANTUM LOW-DENSITY PARITY-CHECK CODES WITH RECONFIGURABLE ATOM ARRAYS

(71) Applicants: President and Fellows of Harvard College, Cambridge, MA (US); QuEra Computing Incorporated, Boston, MA (US); The University of Chicago, Chicago, IL (US); California Institute of Technology, Pasadena, CA (US); Arizona Board of Regents on behalf of the University of Arizona, Tucson, AZ (US)

(72) Inventors: Hengyun Zhou, Cambridge, MA (US); Juan Pablo Bonilla Ataides, Cambridge, MA (US); Dolev Bluvstein, Cambridge, MA (US); Jonathan Wurtz, Boston, MA (US); Mikhail D. Lukin, Cambridge, MA (US); Qian Xu, Chicago, IL (US); Liang Jiang, Chicago, IL (US); Christopher A. Pattison, Pasadena, CA (US); Nithin Raveendran, Tucson, AZ (US); Bane Vasic, Tucson, AZ (US)

(73) Assignees: President and Fellows of Harvard College, Cambridge, MA (US); QuEra Computing Incorporated, Boston, MA (US); The University of Chicago, Chicago, IL (US); California Institute of Technology, Pasadena, CA (US); Arizona Board of Regents on behalf of the University of Arizona, Tucson, AZ (US)

(21) Appl. No.: 19/480,429

(22) PCT Filed: Apr. 30, 2024
(86) PCT No.: PCT/US2024/027037

§ 371 Date: Oct. 31, 2025

Related U.S. Application Data
(60) Provisional application No. 63/499,325, filed on May 1, 2023.
(60) Provisional application No. 63/530,026, filed on Jul. 31, 2023.

(51) Int. Cl. G06N 10/70

(52) U.S. Cl. CPC G06N 10/70

(57) ABSTRACT

Quantum error correction in reconfigurable atom arrays is described. A plurality of data qubits is provided, each of the plurality of data qubits disposed in a corresponding trap. A plurality of ancilla qubits is provided, each of the plurality of ancilla qubits disposed in a corresponding trap. The plurality of data qubits and the plurality of ancilla qubits are arranged in a plurality of rows and a plurality of columns, thereby forming a lattice. A plurality of permutations of the plurality of rows and the plurality of columns is performed, each of the plurality of permutations placing each of the plurality of data qubits within an interaction radius of one of the plurality of ancilla qubits, thereby forming a plurality of proximate pairs. Subsequent to each of the plurality of permutations, a global control pulse is applied to the lattice, thereby applying a gate to each of the plurality of proximate pairs, and thereby encoding a parity check matrix between the plurality of ancilla qubits and the plurality of data qubits.

### CROSS-REFERENCE TO RELATED APPLICATIONS

This application claims the benefit of U.S. Provisional Application No. 63/499,325, filed May 1, 2023 and U.S. Provisional Application No. 63/530,026, filed Jul. 31, 2023, each of which is hereby incorporated by reference in its entirety.

### STATEMENT REGARDING FEDERALLY SPONSORED RESEARCH OR DEVELOPMENT

This invention was made with government support under 1855879, 2100013, 2106189, and 1941583 awarded by National Science Foundation (NSF) and under FA9550-19-0360 awarded by Air Force Office of Scientific Research (USAF/AFOSR). The government has certain rights in this invention.

### BACKGROUND

Embodiments of the present disclosure relate to quantum computation, and more specifically, to dynamically reconfigurable architectures for parallel quantum operations in neutral atom arrays.

### BRIEF SUMMARY

In various embodiments, methods of performing quantum error correction are disclosed. A plurality of data qubits is provided, each of the plurality of data qubits disposed in a corresponding trap. A plurality of ancilla qubits is provided, each of the plurality of ancilla qubits disposed in a corresponding trap. The plurality of data qubits and the plurality of ancilla qubits are arranged in a plurality of rows and a plurality of columns, thereby forming a lattice. A plurality of permutations of the plurality of rows and the plurality of columns is performed, each of the plurality of permutations placing each of the plurality of data qubits within an interaction radius of one of the plurality of ancilla qubits, thereby forming a plurality of proximate pairs. Subsequent to each of the plurality of permutations, a global control pulse is applied to the lattice, thereby applying a gate to each of the plurality of proximate pairs, and thereby encoding a parity check matrix between the plurality of ancilla qubits and the plurality of data qubits.

In some embodiments, prior to forming the lattice, a control laser pulse is applied to the plurality of data qubits to thereby prepare them in an initial state.

In some embodiments, arranging the plurality of data qubits and the plurality of ancilla qubits in the lattice comprises moving, in parallel, the plurality of ancilla qubits into the lattice.

In some embodiments, performing the plurality of permutations comprises moving, in parallel, one or more rows within the lattice and moving, in parallel, one or more columns within the lattice.

In some embodiments, the plurality of ancilla qubits comprises Z stabilizers and X stabilizers.

In some embodiments, a subset of the plurality of ancilla qubits is removed from the lattice and a measurement is performed on the subset. In some embodiments, the subset corresponds to Z stabilizers. In other embodiments, the subset corresponds to X stabilizers.

In some embodiments, performing the plurality of permutations comprises determining a collision-free path for each of the plurality of data qubits and each of the plurality of ancilla qubits for each of the plurality of permutations. In some embodiments, determining the collision-free path comprises bipartition and recursive sorting of the plurality of data qubits and the plurality of ancilla qubits. In some embodiments, the collision-free path is a cubic spline.

In some embodiments determining the collision-free path comprises: decomposing the parity check matrix into a first product graph and a second product graph; determining a routing of the plurality of rows according to the first product graph; and determining a routing of the plurality of columns according to the second product graph. In some embodiments, the plurality of permutations comprises row-specific and/or column-specific permutations. In some embodiments, performing the plurality of permutations comprises: applying a pinning beam to at least one qubit of the plurality of data qubits or the plurality of ancilla qubits, thereby maintaining the position of the at least one qubit according to the routing of the plurality of rows or columns.

In some embodiments, the parity check matrix implements a quantum low-density parity-check (qLDPC) code. In some embodiments, the parity check matrix implements a surface code. In some embodiments, the parity check matrix implements a hypergraph product (HGP) code. In some embodiments, the parity check matrix implements a Calderbank-Shor-Steane (CSS) code.

In some embodiments, the parity check matrix implements a Lifted Product (LP) code. In some embodiments, prior to performing the plurality of permutations, the LP code is flattened. In some embodiments, flattening the LP code comprises iteratively dividing and flattening the LP code.

In some embodiments, the gate applied to each of the plurality of proximate pairs is a CZ gate.

In some embodiments, the global control pulse is a laser pulse.

In some embodiments, the trap corresponding to each of the plurality of data qubits and to each of the plurality of ancilla qubits is an optical trap. In some embodiments, the optical traps corresponding to the plurality of data qubits and to the plurality of ancilla qubits are generated by directing a beam of light to at least one acousto-optic deflector (AOD), and moving the one or more rows and moving the one or more columns comprises varying a drive frequency of the at least one AOD.

In some embodiments, one or more rotations is applied during said moving. In some embodiments, applying the one or more rotations comprises applying a Raman pulse.

In various embodiments, a quantum computing system is provided, comprising a plurality of data qubits, each disposed in a corresponding trap, and a plurality of ancilla qubits, each disposed in a corresponding trap, wherein the quantum computing system is configured to perform any of the forgoing methods.

### BRIEF DESCRIPTION OF THE SEVERAL VIEWS OF THE DRAWINGS

FIG. 1 is a schematic view of a quantum information architecture according to embodiments of the present disclosure.

FIG. 2 is a level diagram showing key ⁸⁷Rb atomic levels according to embodiments of the present disclosure.

FIG. 3 is a schematic view of a quantum processing unit (QPU) according to embodiments of the present disclosure.

FIG. 4 is a schematic view of a lattice of qubits illustrating the product structure of hypergraph product codes according to embodiments of the present disclosure.

FIGS. 5A-C are schematic views of lattices of qubits, illustrating column and row permutations according to embodiments of the present disclosure.

FIG. 6 is a schematic view of a 1-dimensional array of qubits over time, showing a syndrome extraction gate sequence according to embodiments of the present disclosure.

FIG. 7 is a schematic view of a 1-dimensional array of qubits over time, showing the steps of a rearrangement according to embodiments of the present disclosure.

FIGS. 8A-AA are schematic views of a 1-dimensional array of qubits forming a sequence of rearrangement steps to achieve permutation according to embodiments of the present disclosure.

FIG. 9 is a schematic view of a 1-dimensional array of qubits over time, showing the steps of a rearrangement according to embodiments of the present disclosure.

FIG. 10 is a schematic view of an exemplary 2-dimensional graph according to embodiments of the present disclosure.

FIG. 11 is a schematic view of a 1-dimensional array of qubits over time, showing the use of pinning beams to prevent movement in some columns according to embodiments of the present disclosure.

FIG. 12 is a schematic view of a lattice of qubits illustrating the product structure of lifted product (LP) codes according to embodiments of the present disclosure.

FIG. 13 is pseudocode for an algorithm for arbitrary 1D atom rearrangement in a logarithmic number of steps according to embodiments of the present disclosure.

FIG. 14 is pseudocode for a product coloration circuit for HGP syndrome extraction according to embodiments of the present disclosure.

FIG. 15 is pseudocode for a pipelined product coloration circuit for multi-round HGP syndrome extraction according to embodiments of the present disclosure.

FIGS. 16A-D illustrate the efficient implementation of quantum LDPC codes with atom arrays according to embodiments of the present disclosure.

FIGS. 17A-B illustrate the ordering of operations in pipelined syndrome extraction according to embodiments of the present disclosure.

FIG. 18 is a schematic view of an apparatus for quantum computation according to embodiments of the present disclosure.

### DETAILED DESCRIPTION

Quantum low-density parity-check (qLDPC) codes can achieve high encoding rates and high code distances, providing a promising route to low-overhead fault-tolerant quantum computing. However, the high connectivity required to implement such codes makes their physical realizations challenging.

The present disclosure provides a scheme to efficiently implement constant-rate qLDPC codes with reconfigurable atom arrays. This scheme utilizes the product structure inherent in many qLDPC codes to provide streamlined circuit implementations of them. Efficient parallel rearrangement methods are provided for one-dimensional atom arrays, which, when repeated in parallel across different rows or columns, enable stabilizer measurements of qLDPC codes with a number of rearrangement steps that grows only logarithmically with the system size. This work enables low resource overhead quantum computing with qLDPC codes.

A quantum bit (qubit) is the fundamental building block for a quantum computer. By analogy to classical bits which are used to store information in traditional computers (each bit is 0 or 1), qubits can occupy two distinct states labeled |0 [symbol] and |1 [symbol] or any quantum superposition of the two states. In various applications, multiple qubits are entangled in order to build multi-qubit quantum gates.

Bits and qubits are each encoded in the state of real physical systems. For example, a classical bit (0 or 1) may be encoded in whether a capacitor is charged or discharged, or whether a switch is ‘on’ or ‘off’.

The term qudit (quantum digit) denotes the unit of quantum information that can be realized in suitable d-level quantum systems. A collection of qubits that can be measured to N states can implement an N-level qudit.

Quantum bits are encoded in quantum systems with two (or more) distinct quantum states. There are many physical realizations that may be employed. One example is based on individual particles such as atoms, ions, or molecules which are isolated in vacuum. These isolated atoms, ions, and molecules have many distinct quantum states that correspond to different orientations of electron spins, nuclear spins, electron orbits, and molecular rotations/vibrations.

In principle, a qubit may be encoded in any pair of quantum states of the atom/ion/molecule. In practice, a key parameter of qubits is described by their quantum coherence properties. Coherence measures the lifetime of the qubit before its information is lost. It has a close analogy with classical bits: if you prepare a classical bit in the 0 state, then after some time it may randomly be flipped to 1 due to environmental noise. Quantum mechanically, the same error may occur: |0 [symbol] may randomly flip to |1 [symbol] after some characteristic timescale. However, qubits may suffer from additional errors: for example, a superposition state (|0 [symbol] +|1 [symbol] )/√2 may randomly flip to (|0 [symbol] −|1 [symbol] )/√2. In real quantum computers, the qubits must be encoded in quantum states which have long coherence properties.

Quantum computers generally can contain many qubits, each encoded in its own atom/molecule/ion/etc. Beyond simply containing the qubits, the quantum computer should be able to (1) initialize the qubits, (2) manipulate the state of the qubits in a controlled way, and (3) read out the final states of the qubits. When it comes to manipulation of the qubits, this is usually broken down into two types: one type of qubit manipulation is a so-called single-qubit gate, which means an operation that is applied individually to a qubit. This may, for example, flip the state of the qubit from |0 [symbol] to |1 [symbol] , or it may take |0 [symbol] to a superposition state (|0 [symbol] +|1 [symbol] )/√2. The second necessary type of qubit manipulation is a multi-qubit gate, which acts collectively on two or more qubits, including those that are entangled. A multi-qubit gate is realized through some form of interaction between the qubits. The various quantum computing platforms (having various physical encodings of qubits) rely on different physical mechanisms both for single-qubit gates as well as multi-qubit gates according to the physical system that is storing the qubit.

In various embodiments of a quantum computer, a qubit is encoded in two near-ground-state energy levels of an atom, ion, or molecule. An example of this is a hyperfine qubit. Such a qubit is encoded in two electronic ground states that differ by the relative orientation of the nuclear spin with respect to the outer electron spin. Pairs of such states can be chosen so that they are particularly robust/insensitive to environmental perturbations, leading to long coherence times. These states are split in energy by the hyperfine interaction energy of the atom/ion/molecule, which is the interaction energy between the nuclear spin and the electron spin. The robustness of the qubit can be understood as the energy splitting between the two states being particularly stable. For this reason, such states are called clock states because the stable energy splitting can form an excellent frequency-reference and as such forms the basis for atomic clocks. Typical hyperfine splitting between these qubit states is in the 1-13 GHz frequency range.

To perform single-qubit gates on such a hyperfine qubit, it is possible to apply coherent microwave radiation at the exact frequency of the energy splitting between states. However, there are two drawbacks to this approach. First, microwaves cannot be applied to just one qubit without affecting adjacent qubits. This is because qubits are encoded in particles that are typically just a few microns apart from one another, and microwaves cannot be focused to such a small scale due to their large wavelength. Second, the microwave intensity is fairly limited and as such the maximum speed of single-qubit gates is correspondingly limited.

An alternative approach is based on stimulated Raman transitions. In this case, a laser field, also referred to herein as a Raman pulse, is applied to the atoms/ions/molecules. The laser field is nearly (but not exactly) resonant with an optical transition from one of the ground states to an optically excited state. The laser field contains multiple frequency components separated in frequency by exactly the amount equal to the hyperfine splitting of the qubit. The atom/ion/molecule can absorb a photon from one frequency component and coherently emit into a different frequency component, and in doing so it changes its state. This approach benefits from the capability of focusing the laser field onto individual particles or subsets of particles in the quantum computer. The laser field can also be applied with high intensity, enabling much faster gate operations.

Neutral atom quantum computers encode qubits in individual neutral atoms. The neutral atoms are trapped in a vacuum chamber and levitated by trapping lasers. Most commonly, the trapping lasers are individual optical tweezers, which are individual tightly focused laser beams that trap an individual atom at the focus. Alternatively, individual atoms may be trapped in an optical lattice, which is formed from standing waves of laser light which produce a periodic structure of nodes/antinodes.

A typical approach for encoding a qubit in neutral atoms is the hyperfine qubit approach, in which two ground states split by several GHz form the qubit. Multi-qubit gates in neutral atom quantum computers are realized using a third atomic state, which is a highly-excited Rydberg state. When one atom is excited to a Rydberg state, neighboring atoms are prevented from being excited to the Rydberg state. This conditional behavior forms the basis for multi-qubit gates, such as a controlled-NOT gate. The Rydberg state is used temporarily to mediate the multi-qubit gate, and then the atoms are returned back from the Rydberg state to the ground state levels to preserve their coherence.

Trapped ion quantum computers use atomic species that are ionized, meaning they have a net charge. In most cases, many ions are trapped in one large trapping potential formed by electrodes in a vacuum chamber. The ions are pulled to the minimum of the trapping potential, but inter-ion Coulomb repulsion causes them to form a crystal structure centered in the middle of the trapping potential. Most commonly, the ions arrange into a linear chain. Other ways to trap ions are also possible, such as using optical tweezers, or trapping ions individually with local electric fields with a more complex on-chip electrode structure.

Qubits are encoded in trapped ions in multiple ways. One common approach is to use ground-state hyperfine levels, as described for neutral atoms. In trapped ions with hyperfine-qubit encoding, as with neutral atoms, single-qubit gates may use microwave radiation or stimulated Raman transitions.

Unlike in neutral atoms, trapped ion hyperfine qubits rely heavily on stimulated Raman transitions for performing multi-qubit gates. Stimulated Raman transitions may be used to control both the hyperfine state of the ion but also to change the motional state of the ion (i.e., add momentum). This can be understood as absorbing a photon moving in one direction and emitting a photon in a different direction, such that the difference in photon momentum is absorbed by the ion. Since many ions are often trapped in one collective trapping potential and are mutually repelling one another, changing the motional state of one ion affects other ions in the system, and this mechanism forms the basis for multi-qubit gates.

According to various embodiments of a quantum computer, individual particles (atoms/ions/molecules) can first be trapped in an array and arranged into particular configurations. Next, one or more particles are prepared in a desired quantum state. Quantum circuits can then be implemented by a sequence of qubit operations acting on individual qubits (single-qubit gates) or on groups of two or more qubits (multi-qubit gates). Finally, the state of the particles can be read out in order to observe the result of the quantum circuit. The readout can be accomplished using an observation system that typically includes an electron-multiplied CCD (EMCCD) camera image to detect particles' loaded positions, and a second camera image to read out the particles' final states by, for example, detecting fluorescence emitted by the particles in their final states.

Quantum information platforms rely on interactions between qubits, either for performing quantum gates or for performing analog many-body simulation. Qubits often interact in a local way, however, which limits the connectivity of the circuit or the analog simulation and constrains the possible computations. While some platforms can communicate in a nonlocal way through the use of a shared bus (e.g., trapped ions), these shared-bus approaches are limited to small systems and thus still require a way to dynamically move qubits around in order to truly scale up the platform.

Neutral atom arrays can be dynamically reconfigured while preserving quantum coherence and entanglement between qubits, by storing quantum information in hyperfine states and shuttling atoms in optical tweezers. This approach offers a scalable way to realize a quantum information system with large numbers of qubits and arbitrary programmability—where any qubit can perform an entangling gate with any other qubit in the array. Using high-fidelity two-qubit Rydberg gates, various quantum information circuits are described herein that leverage the programmability and nonlocal connectivity achievable with these approaches. Examples of high fidelity Rydberg gates are described in Levine, et al., Parallel Implementation of High-Fidelity Multiqubit Gates with Neutral Atoms, Phys. Rev. Lett., vol. 123, issue 17, https://link.aps.org/doi/10.1103/PhysRevLett.123.170503, and Evered, et al., High-Fidelity Parallel Entangling Gates on a Neutral Atom Quantum Computer, arXiv:2304.05420 [quant-ph], https://arxiv.org/abs/2304.05420, which are hereby incorporated by reference.

As set out in more detail below, the methods provided herein enable a variety of computational scenarios. In some scenarios, a plurality of neutral atom are moved in parallel between multiple regions in space. For example, a source of illumination may be directed to a first region, and atoms are moved in and out of that region between the application of pulses by the source of illumination. Similarly, a camera may be directed to an imaging region, and atoms are moved in and out of that imaging region for imaging. Similarly, atoms may be moved in and out of the blockade radius of other atoms, thereby allowing the application of gates to the different groups of atoms at different stages of an algorithm or layers of a quantum circuit.

It will be appreciated that various stabilizer codes entail the readout of ancilla qubits, and the present disclosure allows the physical relocation of ancilla qubits to an imaging region separate from the data qubits. In this way, readout of ancilla qubits may be provided without destruction of the data qubits.

More generally, an array of atoms may be moved between multiple arrangements to facilitate both digital gates between different selections of atoms and analog evolution of the array as a whole. As used herein, an arrangement of an array of atoms or a plurality of atoms refers to the positioning of those atoms relative to each other. It will be appreciated that certain arrangements provide connectivity between qubits that enable particular gates or analog evolution according to a particular Hamiltonian. One advantage of the methods provided herein is that atoms may be moved into proximity of atoms that were not adjacent within an array. A non-adjacent atom is one that is not within a unit cell in a regular lattice or that is not a nearest neighbor in an irregular array. For example, in a rectangular lattice, each atom has eight atoms that are within a unit cell thereof, and thus has eight adjacent atoms (disregarding edges).

As defined further below, atoms are moved adiabatically in order to preserve entanglement. As used herein, the term adiabatic movement refers to movement that avoids a transition of the subject atom within its trap. For example, where the first time-derivative of the acceleration of the subject atom is not greater than a predetermined value, the movement is considered adiabatic. Typically, adiabatic movement occurs when jerk<(size of atom)×(trap frequency)³. In physics, jerk or jolt is the term given to the rate at which an object's acceleration changes with respect to time.

In addition to adiabatic movement, in some embodiments dynamical decoupling is applied during the movement. As set out further below, a π-pulse during movement cancels out dephasing induced by the trap differential light shift. The trap differential light shift changes when the atom is moving (depending on its acceleration) because it will move in the trap, and so sample a different portion of the light intensity and hence have a different differential light shift.

Generally speaking, the more pulses applied, the more decoupling from fluctuations. For example, fluctuations may come from laser intensity fluctuations at different displacement positions of the atom, or different magnetic fields in space.

In embodiments where acceleration and deceleration are symmetric, both change the differential light shift in the same way. Accordingly, in such embodiments it is advantageous to apply a π-pulse at the midpoint of the motion. In this way, the changes in differential light shift induced by acceleration and deceleration cancel each other out.

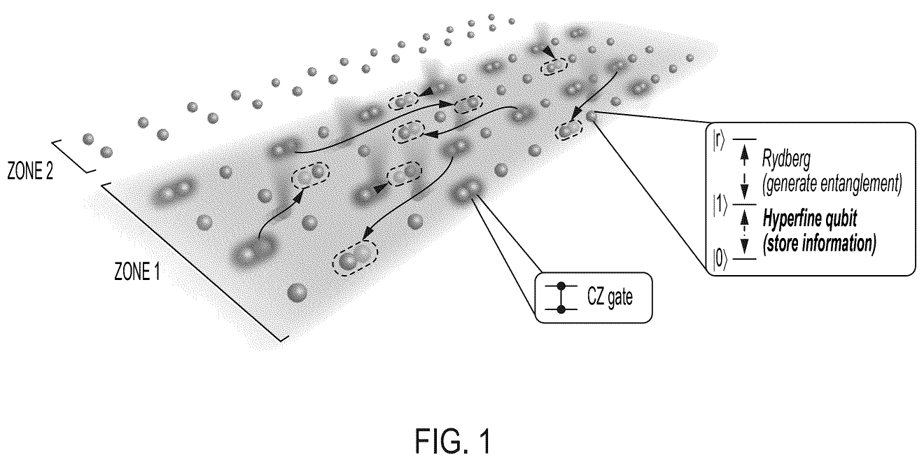

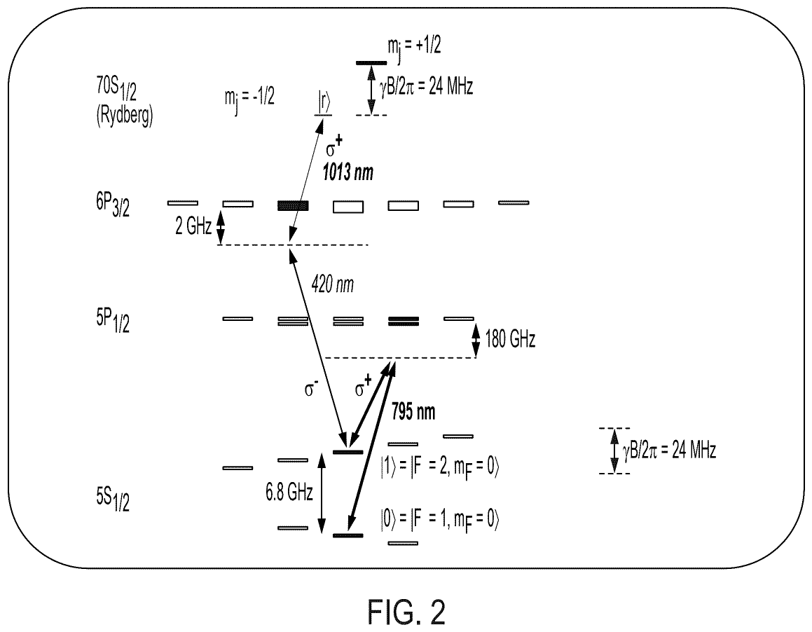

Referring to FIG. 1, a quantum information architecture enabled by coherent transport of neutral atoms is illustrated. Qubits are transported to perform entangling gates with distant qubits, enabling programmable and nonlocal connectivity. Atom shuttling is performed using optical tweezers, with high parallelism in two dimensions and between multiple zones allowing selective manipulations. The inset shows the atomic levels used: the |0 [symbol] |1 [symbol] qubit states refer to the m_{F}=0 clock states of ⁸⁷Rb, and |r [symbol] is a Rydberg state used for generating entanglement between qubits, which are further described with regard to FIG. 2.

FIG. 2 is a level diagram showing key ⁸⁷Rb atomic levels used. The Rydberg excitation scheme from |1 [symbol] to |r [symbol] is composed of a two-photon transition driven by a 420-nm laser and a 1013-nm laser. A DC magnetic field of B=8.5G is applied throughout this work.

As noted above, quantum information systems derive their power from controllable interactions that generate quantum entanglement. However, the natural, local character of interactions limits the connectivity of quantum circuits and simulations. Nonlocal connectivity can be engineered via a global shared quantum data bus, but these approaches are limited in either control or size.

According to various embodiments of the present disclosure, this long-standing challenge is addressed through dynamically reconfigurable arrays of entangled neutral atoms, shuttled by optical tweezers in two spatial dimensions. Hyperfine states are used for storing and transporting quantum information in between quantum operations, and excitation into Rydberg states is used for generating entanglement. Highly parallel operations are enabled via selective qubit operations in distinct zones that qubits are dynamically shuttled between. Taken together, these ingredients enable a powerful quantum information architecture, which is employed to realize applications including entangled state generation, creation of topological surface and toric code states, and hybrid analog-digital quantum simulations.

Within this architecture, programming a specific quantum circuit entails control over only a few optical degrees of freedom. Arbitrary tweezer positions in space are controlled by a computer-generated hologram, hundreds of atoms are dynamically reconfigured in parallel by two waveforms in a 2D acousto-optic deflector (AOD), and qubit operations are realized by pulsing optical beams. This flexible optical control enables sophisticated quantum circuits with only a few classical controls. This architecture enables an inherently scalable approach: larger codes require no increase in the number of classical controls.

Various quantum circuits are realizable with this approach, including quantum error correction (QEC) codes such as the surface and Steane codes, with fidelities in this disclosure already comparable to state-of-the-art experiments in other platforms. Moreover, the parallelized, nonlocal connectivity is used to create the toric code state on a torus.

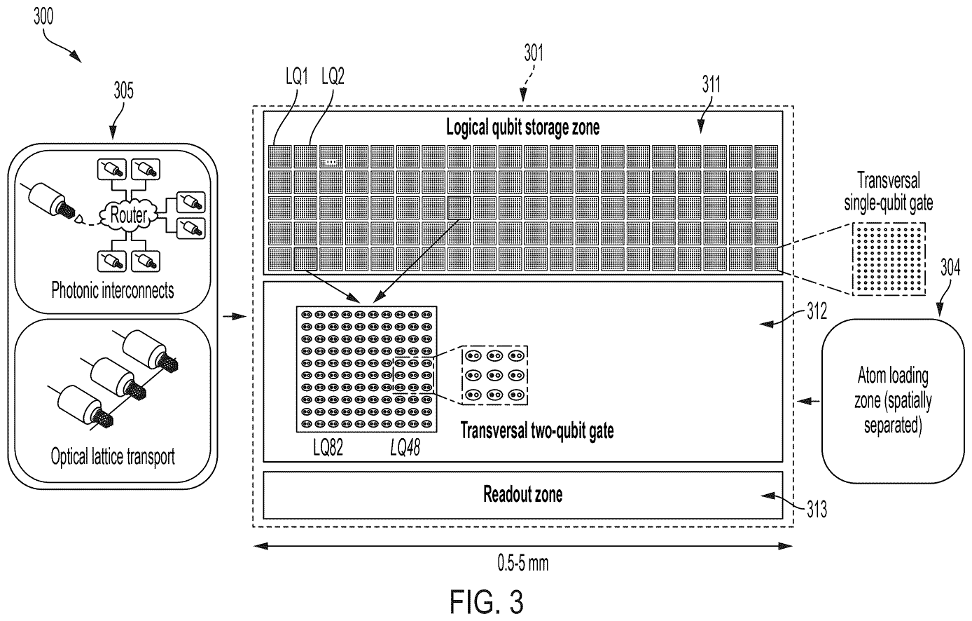

Referring to FIG. 3, a quantum processing unit (QPU) according to the present disclosure is illustrated. This design is centered around efficient classical control over many logical qubits in parallel using optical beams. Single-qubit logical gates can be realized transversally, for example, by illuminating all physical qubits within the same logical qubit block by an optical beam. Two-qubit logical gates can also be realized transversally, by interlacing two logical arrays of qubits and applying a global optical pulse for entangling each twin of the pair. For such a gate to be transversal, it must interact only corresponding qubits from the different logical arrays, such that the first qubit of the first logical array interacts with the first qubit of the second logical array, and so on.

Neutral atom systems have the potential for utility scale computing: for example, millions of identical neutral atom qubits may be trapped in mm-scale regions of space. The key challenge is the classical control required to assemble these qubits into a large-scale quantum processor. Full programmability of single physical qubits generally requires highly complicated classical control techniques in order to operate on millions of qubits. In contrast, the architectures provided herein allow for full programmability of single logical qubits while only requiring a few classical controls per logical qubit. This enables reaching utility-scale by encoding logical qubits into blocks that can be efficiently controlled in parallel. Using advanced optical microscopy systems (such as those utilized for modern industrial-scale lithography) with high numerical aperture and large field of view exceeding several millimeters, and appropriately scaled trapping laser power, direct trapping and manipulation of over a million qubits is possible. Further scaling is possible by creating 10-100 such processing units, each under its own microscope objective, and then connecting these units together utilizing photonic links and/or optical lattice transport. This allows for sufficient space, resolution, and power density for enacting high-fidelity control over 10M qubits and beyond.

QPU 300 is segmented into several key zones: a storage zone 311, entangling zone 312, readout zone 313, atom loading zone 304, and remote entangling zone 305. Storage zone 311, entangling zone 312, and readout zone 313 form processor core 301, which in some embodiments contains 10⁴ to 10⁶ qubits in a footprint of 0.5-5 mm. Fresh atoms are continuously reloaded from distant atom loading zone 304, and a distant remote entangling zone 305 (using optical interconnects and/or lattice transport) delivers remote Bell pair entanglement resources.

In storage zone 311, idle logical qubits are stored for long times, utilizing the long qubit coherence times and high fidelity single-qubit gates, such that an error-correction cycle is only required before a logical two-qubit gate. For coherence times of 10-100 second, and assuming performance 10× below threshold, then roughly 1% single-qubit dephasing errors can be tolerated before a round of d cycles of error correction. This corresponds to approximately 0.1-1 second of allowed storage time before the requirement for correction. Due to the all-to-all connectivity provided by the presently described architectures, idled logical qubits can simply be kept in the storage zone, safe from additional errors. Logical qubits are thus stored in dense blocks, shuttled out when they are needed in the algorithm, and only error-corrected before a two-qubit gate, greatly reducing the error correction overhead. In various exemplary devices, atoms are stored at densities of approximately 1/(2 μm)² in the dense storage zone, and densities of approximately 1/(10 μm)² in the active zone.

The active logical qubits are manipulated in active zone 312. By utilizing qubit transport, all combinations of two-qubit gates can be performed in a fixed region of space. This significantly reduces the classical control complexity. For example, all two-qubit gates can be performed using a single, global optical beam, which is dramatically simpler than addressing each individual qubit. This exceptional degree of parallelism for logical qubit control is a significant advantage of the present architecture relative to alternatives such as those involving individual control of atomic qubits.

Readout zone 313 allows selectively reading out a subset of qubits mid-circuit without disturbing the other qubits. This readout happens in parallel with a global beam and a camera, again requiring only one set of classical controls.

Outside of the core processor 301, atoms are constantly reloaded from loading zone 304 and transported into the core processor for running arbitrarily long circuits. Remote Bell pairs with other processing units are generated using optical links and/or optical lattice transport 305, and are shuttled into the core processor 301 for creating remote logical entanglement. This allows interconnection of 10-100 single processing units into one error-corrected, utility-scale quantum computer.

The architecture provided above allows for mid-circuit readout. In particular, this architecture may be paired with fast imaging in the readout zone and a classical control loop. In addition, various methods may be used to suppress crosstalk errors and detect/correct for loss. Arbitrarily long circuit depths may be achieved with continuous reloading of atoms and further crosstalk suppression.

To connect multiple units, many high-fidelity, long-distance Bell pairs may be generated in parallel, using lattice transport and/or photonic links.

It will be appreciated that the present architecture is suitable for logical state preservation by repetitive mid-circuit measurement and correction. In addition, a surface code logical qubit may be implemented, for example by moving ancillas from a storage zone reservoir, entangling with data qubits for syndrome extraction, and moving to the readout zone. This allows fast mid-circuit readout and feedback while preserving coherence on data qubits. In various embodiments, the data qubits are protected by placing the imaging zone ~50 microns away, thereby suppressing crosstalk from the readout beam and scattered light from the ancilla atoms.

In various embodiments, a fast classical control loop uses ancilla measurements to determine errors on the data qubits, and to detect and correct qubit loss. Lost qubits may then be replaced with reservoir atoms. In order to reach surface code distances several times larger than the largest codes created in alternative systems, local detuning patterns may be utilized for space-efficient use of the entangling zone.

The presently described architectures may also be used to perform algorithms with logical qubits. The zoned approach combined with efficient optical control over many logical qubits in parallel allows construction of large-scale processors. In an exemplary use case, ~10 logical qubits are encoded in the active zone and moved to the storage zone. After encoding all logical qubits, the algorithm is run with appropriate logical single-qubit and logical two-qubit gates. The flexible, local single-qubit control required for logical single-qubit gates is implemented with Raman light from a 2D AOD illuminating the grid of a single code block. Logical two-qubit gates are realized transversally in the entangling zone. Mid-circuit readout is used for the non-Clifford gate-teleportation sequence, followed by fast feedback for logical single-qubit rotation.

It will be appreciated that while certain operating parameter are provided below by way of example, increased fidelity in two-qubit gate errors may be achieved through various further optimizations. For example, increasing Rydberg laser power and detuning will reduce laser scattering errors and also suppress other errors by increasing gate speed. Cooling atoms to the motional ground state (thereby suppressing Doppler dephasing errors), and utilizing 10× higher laser power, theoretically results in >99.8% gate fidelities. Further improvements can be made with continued increases in laser power, but alternative routes such as single-photon excitation to Rydberg P states or alkaline-earth-based systems, are also available. Processor speed can be increased to a ~10 microsecond logical qubit cycle time by increasing collection efficiency or utilizing cavity-based or ensemble-based readout schemes, or by increasing movement speed with deeper optical tweezers.

To reach arbitrarily deep circuits, atoms may be continuously reloaded. Accordingly, some embodiments employ loading into a distant magneto-optical trap (MOT) and transporting atoms in an optical lattice conveyor belt.

In various embodiments, cross-talk during readout is suppressed by moving the ancilla atoms away from the data qubits.

Further scaling of the quantum processors can be achieved by connecting more than one microscope objective, either through atom transport or optical communication links. In various embodiments, the first approach utilizes the novel capabilities of atom rearrangement, combined with the use of optical lattice conveyor belts to coherently transport qubits between multiple active optical control regions and distribute entanglement. In various embodiments, the second approach utilizes photon-mediated entanglement between distinct atom array nodes with >10⁴ qubits. High entanglement rates can be achieved through parallel nanophotonic or bulk optical cavities, and the large sizes of atom arrays can provide further parallelism. This approach also enables modular construction of quantum processor units, flexibly rewired and linked together.

Quantum error correction (QEC) lies at the heart of fault-tolerant quantum computation (FTQC). A crucial component of FTQC is the error-correcting code, which describes how to encode quantum information in a redundant way with the goal of lowering the error rate of computation. Quantum error correction is typically implemented by measuring Pauli operators (called stabilizer generators) of a QEC code (referred to as a stabilizer code) to detect faults. An important subclass of stabilizer codes is Calderbank-Shor-Steane (CSS) codes, in which all non-identity components of stabilizer generators are either all Pauli X or all Pauli Z operators. Quantum error correction in CSS codes works by measuring all the stabilizer generators and applying a correction based on the outcomes observed.

Low-density parity-check (LDPC) codes are a natural class of CSS codes to consider for implementation. They are families of stabilizer codes in which every stabilizer generator acts on a constant number of qubits and every qubit is involved in a constant number of generators. The code words of a parity check code are formed by combining a block of binary-information digits with a block of check digits. Each check digit is the modulo 2 sum (i.e., a sum that equals 1 if the ordinary sum is odd and 0 if the ordinary sum is even) of a pre-specified set of information digits. The formation rules for the check digits are represented by a parity-check matrix H, wherein the columns of H represent the binary-information digits, and the rows of H represent the check digits. Low-density parity-check codes are codes specified by a parity check matrix containing mostly 0's and relatively few 1's, such that the columns and rows have a relatively small weight (i.e., sum across columns or rows). The parity check matrix is thus a sparse matrix.

LDPC codes have been very successful in the classical setting as they approach upper bounds on the amount of information that can be reliably transferred through a noisy channel. Many modern technologies such as WiFi, DVB-T, and 5G are error corrected by LDPC codes. Their quantum generalization requires additional conditions to be satisfied, namely that the X and Z checks commute. Families of such codes have been constructed. However, traditional schemes for achieving quantum error correction, such as the surface code, are typically very costly in terms of resource overhead, requiring millions of qubits to solve problems of interest.

Approaches based on quantum low-density parity-check (qLDPC) codes provide a promising route to reduce the resources required, potentially enabling quantum computation with constant space overhead. However, long-range connectivity between qubits is necessary to have qLDPC codes with better code parameters (number of encoded qubits, code distance), making their physical realization rather challenging. The long-range and multi-layer connectivity required has not previously been demonstrated.

The present disclosure demonstrated the implementation of qLDPC codes with reconfigurable atom arrays (RAAs), the hardware architecture for quantum computation described above. The product structure present in many qLDPC codes naturally matches the parallelism afforded by acousto-optic deflectors, a core technology of the RAA platform. Combined with a new algorithm to perform arbitrary 1D qubit rearrangement in log(L) time (L is the linear dimension of the system), while respecting the hardware constraints of current atom shuttling technologies, this results in efficient implementations of qLDPC codes that are within reach of demonstrated experimental capabilities.

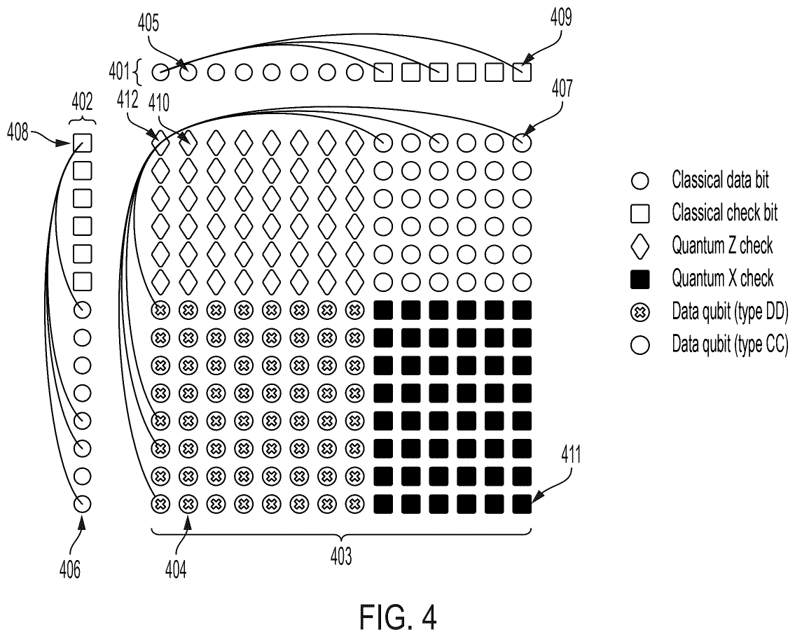

Referring to FIG. 4, the product structure of hypergraph product codes is illustrated. The hypergraph product code is constructed from two classical LDPC codes. The classical codes are illustrated on the left and top, where circles indicate data bits and squares indicate check bits. A data qubit is placed at each intersection of two classical data bits (type DD, filled circles with crosses) and of two classical check bits (type CC, filled circles without crosses). Z stabilizer checks are placed at the intersection of horizontal data bits and vertical check bits, while X stabilizer checks are placed at the intersection of horizontal check bits and vertical data bits. Each stabilizer is connected to data bits along the same row and column, with the same connectivity as the classical codes, as illustrated for the top left Z check. Other connections have been omitted for ease of visualization.

Quantum error correcting codes seek to encode a number of k logical qubits into a larger number of n physical qubits. One particularly convenient method to achieve this is with the stabilizer formalism, in which one applies a number of stabilizer checks to the physical qubits, monitoring the eigenvalue of certain products of Pauli operators on them. For simplicity, the following discussion focuses on CSS codes, in which each stabilizer generator is either a product of X operators, or a product of Z operators, as described above. Logical operators are operators that commute with all stabilizers, but are not contained in the span of the stabilizers. The minimum weight logical operator (i.e., the logical operator with the fewest number of non-identity elements) defines the code distance d, which provides a rough characterization of the number of errors that a given code can handle. Together, the parameters [[n, k, d]] provide a useful characterization of a QEC code.

For quantum codes, all operations are performed with the use of imperfect quantum gates. This is in contrast to the classical communication setting, where the encoding and decoding steps are almost perfect, and errors only occur during the communication itself. Thus, in order for the syndrome extraction to be fault-tolerant, it is likely necessary for all qubits to be involved in a bounded number of operations; in other words, the QEC code should be a low-density parity-check code, where each stabilizer has a constant weight that does not grow with the code size, and each data qubit is involved in a constant number of stabilizers.

The surface code is an example of a qLDPC code. However, unlike many other such codes, a single surface code patch encodes only a single logical qubit, thus requiring many patches—and hence a large overhead—to encode many logical qubits. In contrast, additional families of qLDPC codes are able to achieve a constant encoding rate, meaning that the ratio of logical qubits to physical qubits stays constant as the code size grows. In addition, “asymptotically good” families of such codes are available, in which both the number of encoded qubits and the code distance scale linearly with the number of physical qubits, thereby enabling low-overhead quantum computing, where the resource costs are much reduced compared to conventional schemes.

Another example of a qLDPC code, which also forms the basis of subsequent ones, is the hypergraph product code (HGP). A hypergraph is a graph when every edge connects to exactly two vertices and thus each edge has a cardinality of two. Here, one starts from two classical LDPC codes, and constructs a quantum code from the product of the two classical codes that inherits many of the properties of the classical codes. As illustrated in FIG. 4, one can construct a hypergraph product starting from two classical LDPC codes, placed horizontally (401) and vertically (402), respectively. On the associated 2D grid (403), a data qubit is placed at every intersection (filled circles with crosses) of a data bit and data bit (e.g., data qubit 404 at the intersection of data bit 405 and 406), and at every intersection (filled circles without crosses) of a check bit and check bit (e.g., data qubit 407 at the intersection of check bit 408 and 409). At every intersection of a horizontal data bit and a vertical check bit, a Z stabilizer check is placed (e.g., stabilizer qubit 410 at the intersection of data bit 405 and check bit 408), while at every intersection of a horizontal check bit and a vertical data bit, an X stabilizer check is placed (e.g., stabilizer qubit 411 at the intersection of check bit 409 and data bit 406). Along each row and column of the quantum code, qubits are connected in the same way as their corresponding classical codes, as illustrated for the top left Z check 412.

Logical operators are inherited from the underlying classical code, and one can choose a basis such that each logical qubit has support in a single row or column. Mathematically, if the parity check matrix (where rows describe bits that should sum to an even number in the absence of errors) of the two underlying classical codes is denoted as

$${H}_{1} ∈ {𝔽}_{2}^{{m}_{1} \times {n}_{1}} ,$$

$${H}_{2} ∈ {𝔽}_{2}^{{m}_{2} \times {n}_{2}} ,$$

the X and Z stabilizer check matrices for the HGP code can be written as

$${H}_{x} = ( \begin{matrix}{H}_{1} ⊗ {I}_{{n}_{2}} & {I}_{{m}_{1}} ⊗ {H}_{2}^{T} )\end{matrix} \qquad Equation 1$$

$${H}_{z} = ( \begin{matrix}{I}_{{n}_{1}} ⊗ {H}_{2} & {H}_{1}^{T} ⊗ {I}_{{m}_{2}}\end{matrix} )$$

For classical [nᵢ, kᵢ, dᵢ] codes with rᵢ linearly-independent checks (i=1,2), the resulting quantum code has parameters [symbol] n₁n₂+r₁r₂, k₁k₂, min{d₁, d₂} [symbol] . The surface code is a special case of hypergraph product codes, with the classical codes being 1D repetition codes. However, by instead choosing classical expander codes as the underlying classical codes, where kᵢ=O(n₁), dᵢ=O(nᵢ), the resulting quantum code (known as a quantum expander code) encodes a linear number of logical qubits k=O(n) and has a distance d scaling as d=O(\sqrt{n}). The distance d is the minimum number of qubits that must be touched in order to change one logical codeword to a different logical codeword. The distance d addresses the ability of the QEC code to correct errors, and a code with distance d can correct arbitrary errors affecting up to (d−1)/2 physical qubits. This is because an error E that anticommutes with an element M of the stabilizer changes the eigenvalue of the codeword from +1 for M to −1. Thus, measuring the eigenvalues of the generators of the stabilizer yields a binary vector of length n−k called the error syndrome, which can be used to identify which error occurred. Due to the expansion properties of the underlying graphs, quantum expander codes support single-shot quantum error correction, meaning that repeated rounds of syndrome extraction are not required to achieve fault-tolerance, unlike the surface code.

Although HGPs are not “asymptotically good,” in the sense that their distance does not scale linearly with the number of qubits, they form the basis of subsequent constructions that do achieve linear distance, where additional symmetry reductions are used to lower the number of qubits required to achieve a given distance. Thus, understanding the properties of HGP and being able to realize them also forms the foundation for implementing more complex code families.

Numerical simulations of HGP codes produce promising performance. Using a hypergraph product between classical expander codes constructed from (3,4)-biregular graphs, several studies have examined the thresholds and logical error rates, finding promising circuit-level thresholds of 0.28% and strong evidence that such codes can outperform surface codes as logical memories at moderate system sizes.

In order to achieve desirable code parameters, a certain number of long-range connections are required. In the present disclosure, reconfigurable atom arrays (RAAs) are employed as a platform to provide that connectivity. In this approach, qubits are encoded in long-lived hyperfine or nuclear degrees of freedom of the atom, with coherence times exceeding 1 second. Raman transitions are used for single-qubit manipulation, and strongly-interacting Rydberg states are used for two-qubit entangling gates. Due to the blockaded nature of Rydberg interactions, the gate action is insensitive to the precise location of the atoms, and operates whenever two atoms are next to each other under global gate laser illumination.

By coherently shuttling the atoms around in optical tweezers, one can reconfigure the processor connectivity on the fly and realize parallel two-qubit gate operations across the whole system. Crucially, optical tools such as acousto-optic deflectors (AODs) allow rapid parallel movement of entire grids of atoms, with only a few classical controls per logical qubit, as opposed to common approaches that require a few classical controls per physical qubit. Together with static spatial light modulator (SLM) optical tweezers that can produce arbitrary trap patterns, and the ability to transfer between AOD and SLM traps, one can realize arbitrary connectivity.

The RAA platform features efficient, parallel control and rearrangement of large numbers of qubits, enabling the implementation of long-range connected quantum processors. In addition, as explained above, qLDPC codes with improved code parameters (number of encoded qubits, code distance) rely on randomized expander graphs, for which the connectivity graph is much more complex. The present disclosure shows that despite these constraints, it is possible to efficiently implement the operations needed for HGP codes, in a rearrangement depth that scales only logarithmically with the number of qubits involved. Key to this construction is the realization that the product structure of HGPs is well-matched to the product structure of current AOD hardware. Combined with a new 1D parallel rearrangement scheme that achieves arbitrary permutations in log-depth without atom crossings, these techniques enable the near-term implementation of qLDPC codes.

To fault-tolerantly prepare an HGP code state, such as one where all logical qubits are initialized in |0_{L} [symbol] , all physical qubits are first prepared in |0 [symbol] , then all stabilizers are measured to project into the code space. Repeated measurements of all stabilizers and performing Pauli frame tracking allows one to preserve logical quantum information. A transversal readout of all physical qubits in one basis allows fault-tolerant measurement of the logical state. Thus, most key operations are straightforward, and the nontrivial part is the stabilizer measurement.

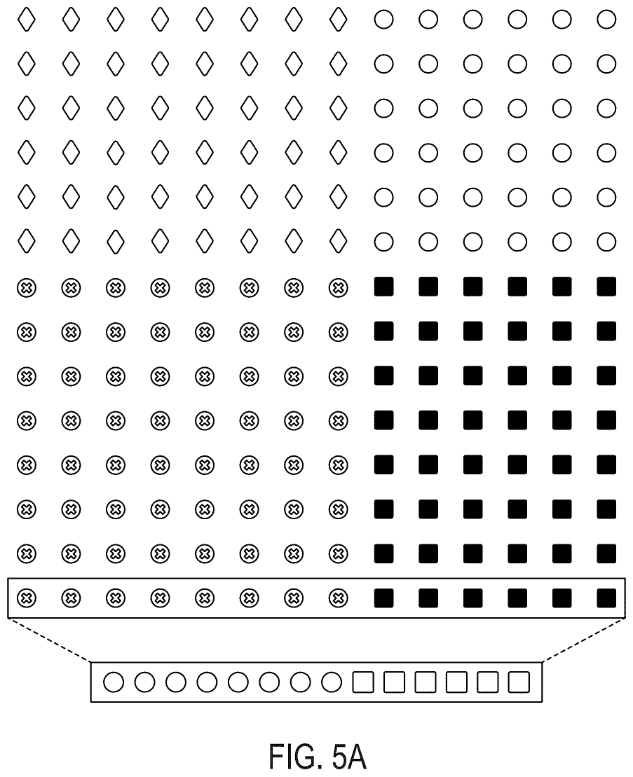

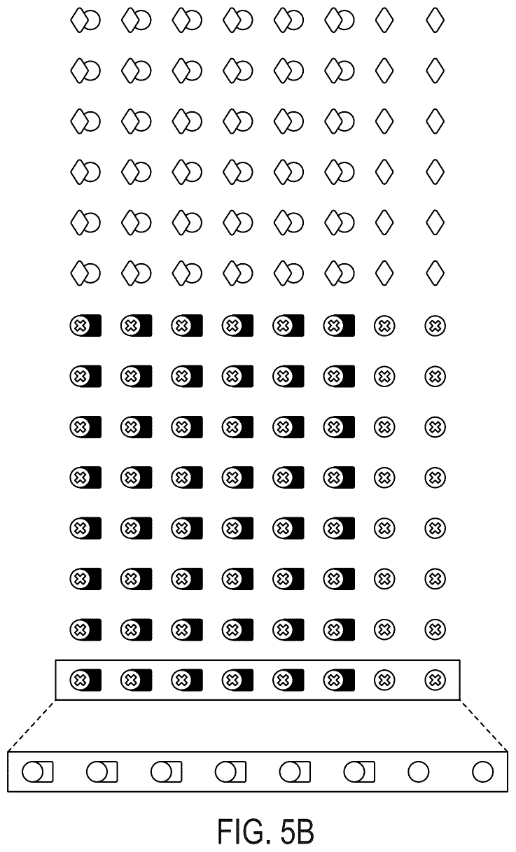

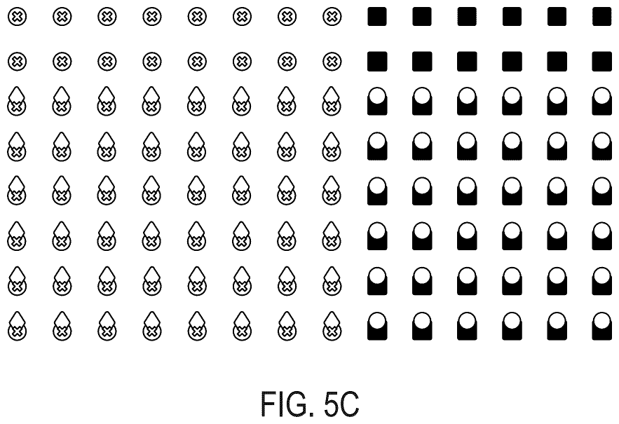

Referring to FIGS. 5A-C, syndrome extraction via permutations is illustrated. FIG. 5A shows an initial configuration of the qubits (maintaining the legend from FIG. 4). FIG. 5B shows the result of column permutation, and FIG. 5C shows the result of subsequent row permutation. Due to the product structure of hypergraph product codes, column (row) permutations are sufficient to implement all stabilizer measurements. The same permutation is applied in parallel across all columns (rows).

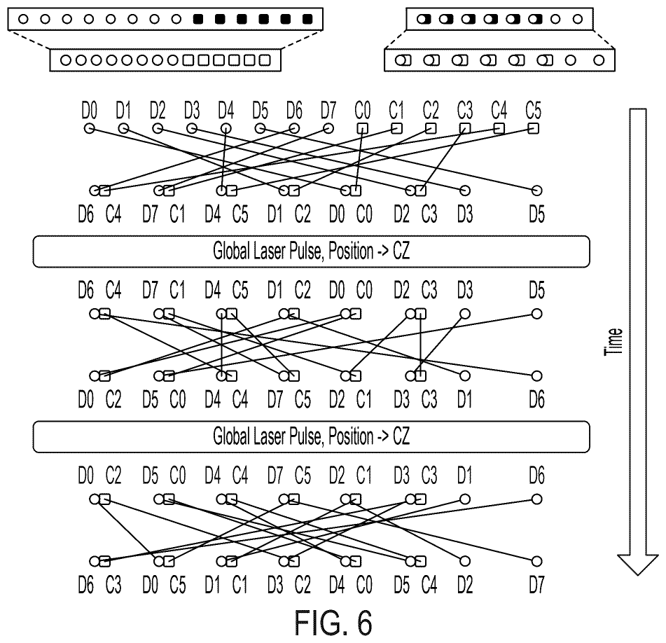

Referring to FIG. 6, a syndrome extraction gate sequence is illustrated, with each row of qubits showing a configuration at a given point in time with the grey lines indicating movement between configurations. As discussed in connection with FIGS. 5A-C, each of the two dimensions of the HGP originates from a classical code and has the same connectivity (top). By interleaving parallel qubit rearrangements with global two-qubit gate laser pulses, the desired syndrome extraction circuit is implemented. Time runs down the page and the gray lines show the path of the data and ancilla qubits from one time step to the next.

As explained above, the stabilizers of the HGP code are inherited from the corresponding checks in the classical code. As illustrated in FIG. 4, each stabilizer check is only connected to qubits in the same row or column. In the horizontal direction (similar for vertical), the parity check connectivities of the classical code are copied along all rows. Thus, by bringing together two columns that were connected in the original classical code, the required gates between all pairs of qubits in those two columns are implemented.

Syndrome extraction thus involves first performing parallel column permutations to rearrange atoms into pairs, where each pair involves a single data bit and check bit that is connected in the horizontal classical code. By using the coloration circuits described, the number of permutation layers required is equal to the largest stabilizer weight in the classical code. As illustrated in FIG. 6, each layer of rearrangement is interleaved with a global Rydberg laser pulse, which implements a CZ gate between each pair of neighboring atoms. Repeating the same procedure along the vertical direction, row permutations are performed to implement all required connections in the vertical direction, thus completing one round of syndrome extraction.

To ensure that the correct stabilizers are extracted, the relative ordering of the gates involved in an X check and Z check that involve two shared data qubits must satisfy the following condition: the X check should interact with both qubits before the Z check, or with both qubits after the Z check. When the X and Z syndromes of the same cycle are extracted simultaneously, this condition cannot be satisfied, implying that in this case, full syndrome extraction requires two full cycles of row and column rearrangements. However, the syndrome extractions can be staggered, such that one round of X syndromes is extracted, then the Z syndrome of the current round is extracted simultaneously with the X syndrome of the following round. This ensures that the relative ordering is satisfied and thus that the syndrome extraction schedule is valid.

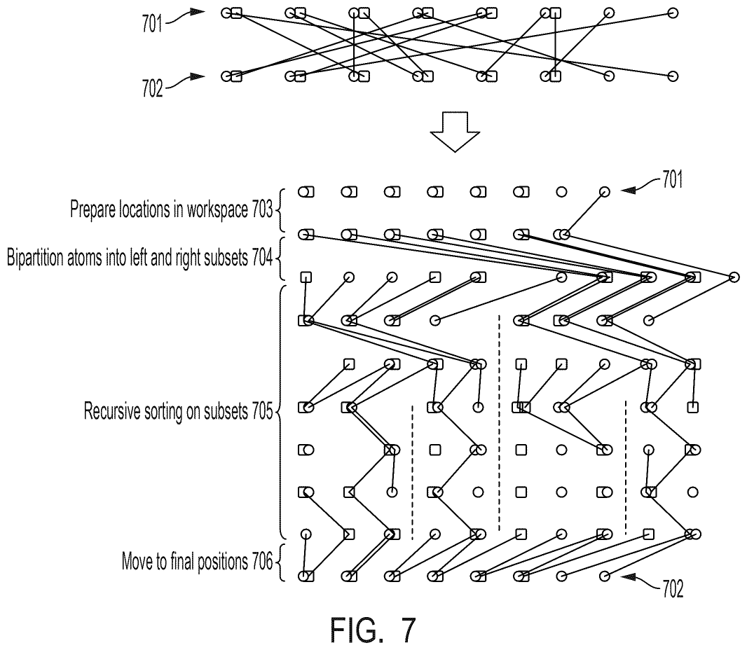

Referring to FIG. 7, efficient non-intersecting rearrangement in log-depth is illustrated. By using a divide and conquer algorithm, an arbitrary 1D rearrangement is performed in depth logarithm in the number of qubits. Repeating this across the array yields an efficient implementation of the desired rearrangements, without requiring intersecting atom trajectories that may lead to additional loss and decoherence. In order to obtain a set of rearrangement steps to move from initial arrangement 701 to final configuration 702, the initial arrangement is prepared 703 in the workspace. The qubits are bipartitioned 704 into left and right subsets. Recursive sorting is performed 705 on the subsets. The qubits are then moved 706 to their final positions.

Arbitrary row or column permutations can be efficiently performed while respecting the hardware constraints of AOD-based atom shuttling. One constraint is the fact that different tones in an AOD, which generate different optical tweezer beams, are not allowed to cross while moving. This is due to the frequency beating that occurs when two tones approach each other, which can heat the atoms, as well as possible atom-atom collisions. It is thus necessary to develop efficient non-intersecting atom rearrangement schemes, in order to realize the permutations required for syndrome extraction.

A divide-and-conquer algorithm is provided herein, which decomposes an arbitrary one-dimensional permutation into a logarithm number of layers, where each layer consists of non-intersecting atom moves that can be performed in parallel. As shown in FIG. 7, the aim is to place all L atoms with final positions in the right half of the system into the correct side. This is achieved by first moving all atoms to the left-most available static SLM trap locations in the workspace (first layer in FIG. 6), then moving all atoms that will end up in the right half to the right-most L/2 static traps in the system. The same procedure is recursively applied to the left half and right half of the system, as illustrated in the middle of FIG. 7, until the desired ordering of atoms is reached. A final parallel AOD move transports the atoms to their desired location for gate operations.

Since every two layers reduces the system size by half, the total number of layers required to achieve the desired rearrangement is O(log L). Thus, arbitrary rearrangements in very large systems can be achieved in a small number of layers. Although this method shares some similarities to techniques such as bitonic sorting, the different constraints (comparators vs. parallel moves) lead to differences in the algorithm itself.

For the schemes described above, one can estimate the amount of time required to implement one round of stabilizer measurements using the technology that has been demonstrated. The following assumptions are employed: a transfer time τₜ between a static SLM trap and dynamic AOD trap, a peak atom moving acceleration rate of aₚ with a cubic spline trajectory, and a uniform grid spacing d. For simplicity, it is further assumed that the number of atoms on a line to be rearranged is a power of 2, L=2^{k}. In order to provide enough workspace for shuttling, the total number of traps is 3L/2.

The compactification step at scale s requires a move of distance at most sd/2. Moving all target atoms to the right requires a move of distance at most sd. The two steps can be combined such that atoms for the next move are picked up and atoms from the previous move are dropped off at the same time; thus, each layer requires on average one trap transfer between static and dynamic traps. Using a cubic spline movement trajectory, a move of distance l requires time \sqrt{6l/aₚ}.

The total time required for one layer of full rearrangement is thus

$${t}_{rearrange} = 2 {k τ}_{t} + {\sum }_{i = 0}^{k} ( \frac{\sqrt{6 \cdot {2}^{i} d}}{{a}_{p}} + \sqrt{\frac{3 \cdot {2}^{i} d}{{a}_{p}}} ) < 2 {τ}_{t} log L + ( 3 + 2 \sqrt{2} ) \sqrt{\frac{6 Ld}{{a}_{p}}} \qquad Equation 2$$

Recent experiments have demonstrated parameters on the order of τₜ=50 μs,

$${a}_{p} = \frac{0.02 μm}{{μs}^{2}} ,$$

d=5 μm. For a moderately sized code consisting of 10,000 qubits (including both data and ancilla qubits), L≈100. The total trap transfer time is 0.7 ms and the atom movement time is 2.3 ms, for each gate layer. Assuming a [3,4]-biregular graph for the underlying classical expander code, 8 rounds of rearrangement are required to measure one full round of stabilizers, resulting in a total time overhead of 24 ms, a small fraction of the coherence time of 2 s that has been demonstrated in neutral atom arrays. Although this timescale is somewhat longer than the typical readout timescales, the HGP code is single shot and, consequently, only a single round of stabilizer measurement is required to perform error correction.

The present disclosure provides techniques for the efficient implementation of quantum low-density parity-check codes in reconfigurable atom arrays. These methods exploit the inherent parallelism of existing optical tools and product structure of many code constructions, enabling their efficient implementation on existing hardware.

These techniques are applicable to other code families that introduce additional ingredients on top of the hypergraph product structure. Moreover, these schemes can be readily extended to the implementation of lattice surgery gates on qLDPC codes, where the ancilla code patches can be viewed as a hypergraph product code between a subsection of the original code and a repetition code. The present disclosure enables near-term implementations of qLDPC codes and significantly reduces the resources required for large-scale fault-tolerant quantum computation.

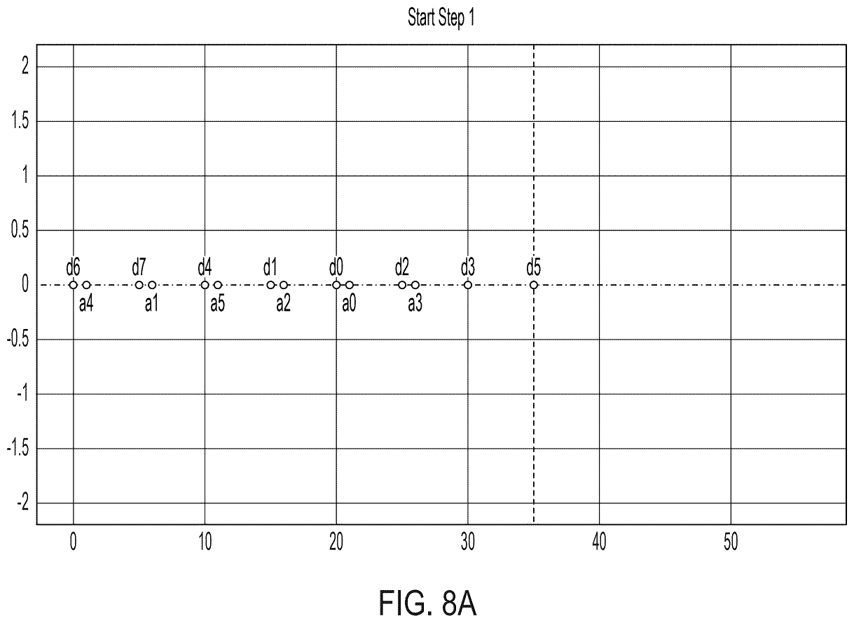

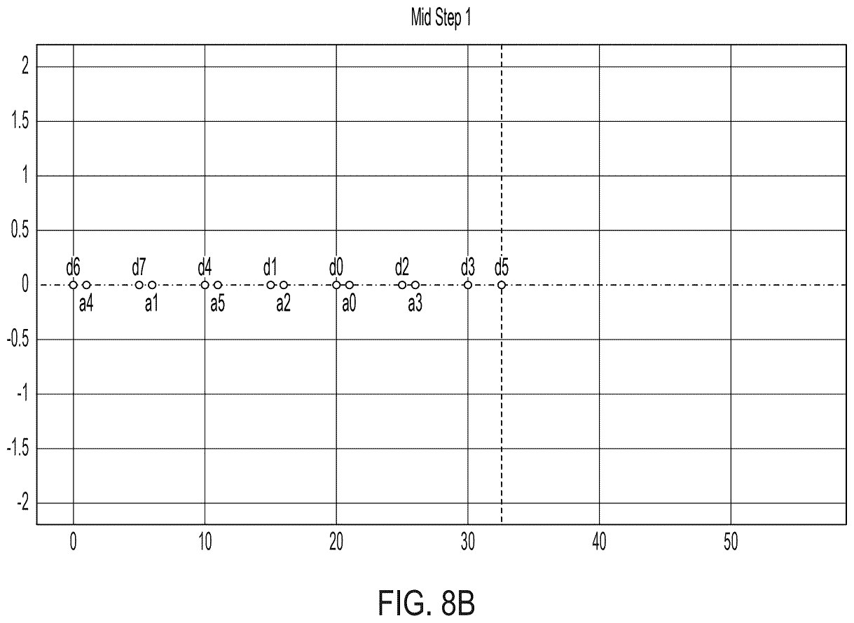

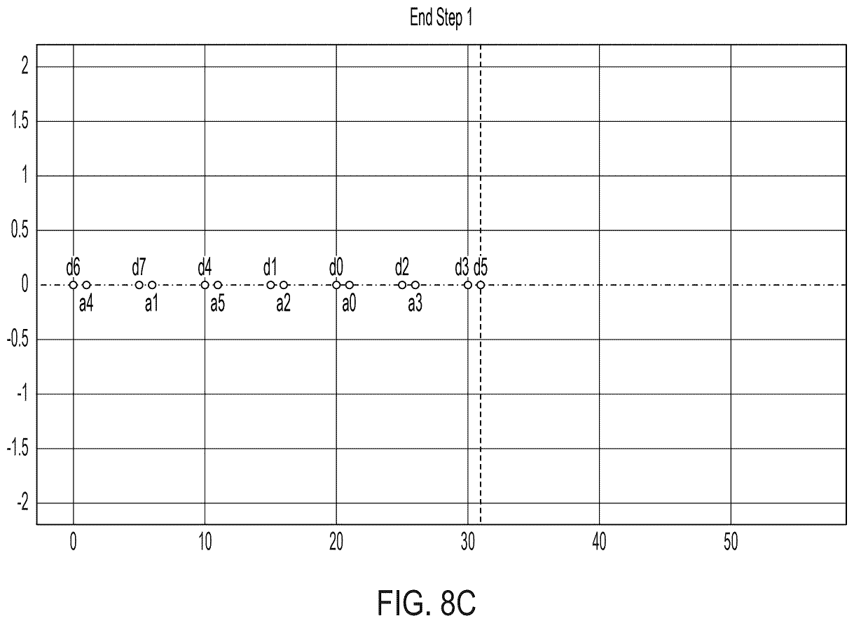

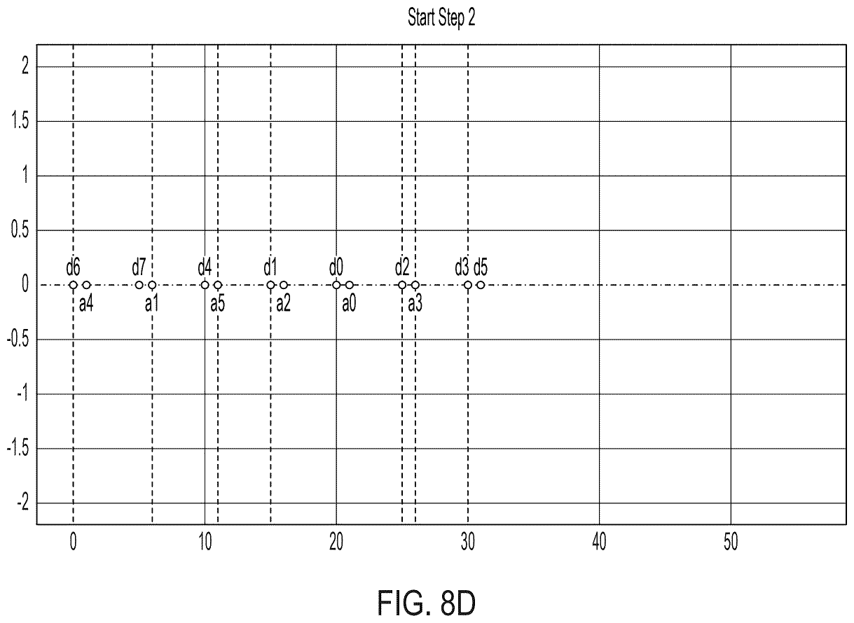

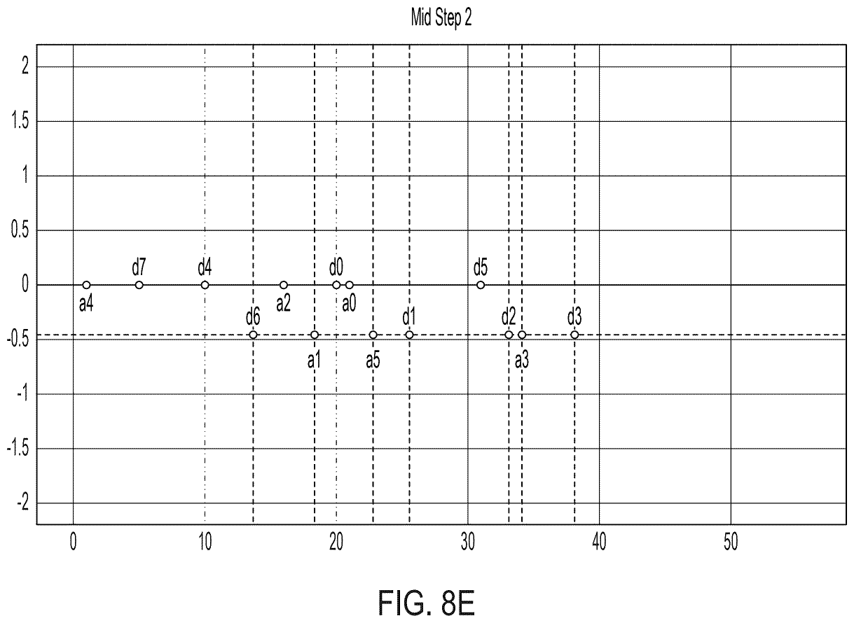

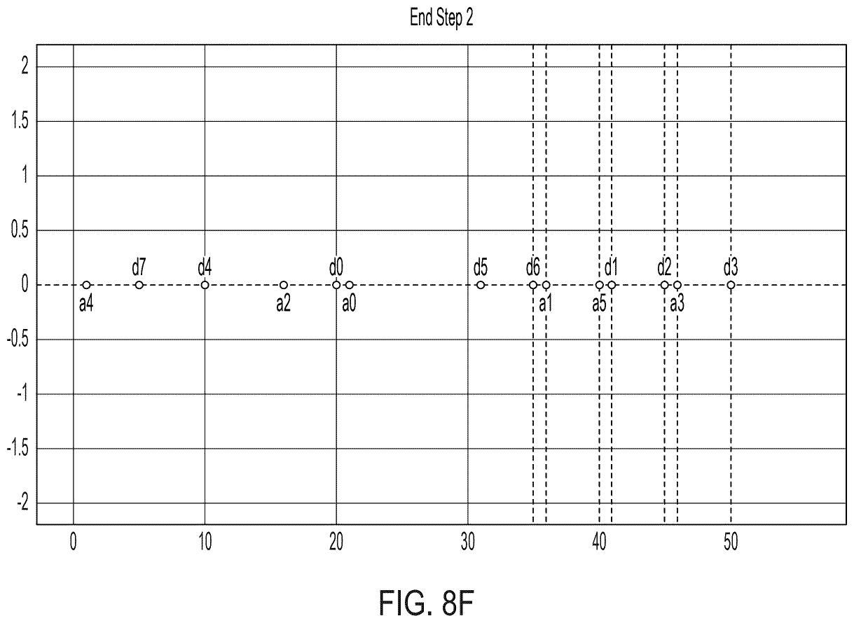

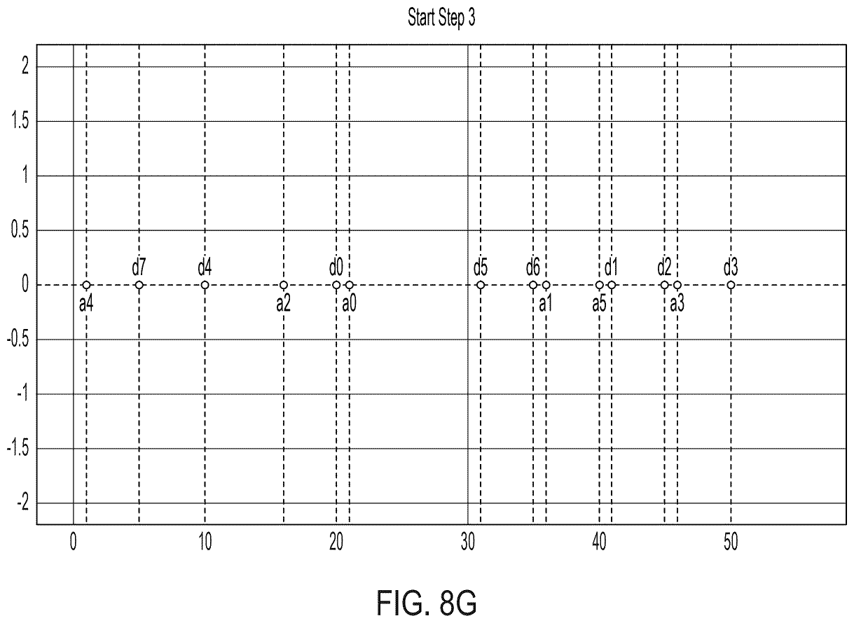

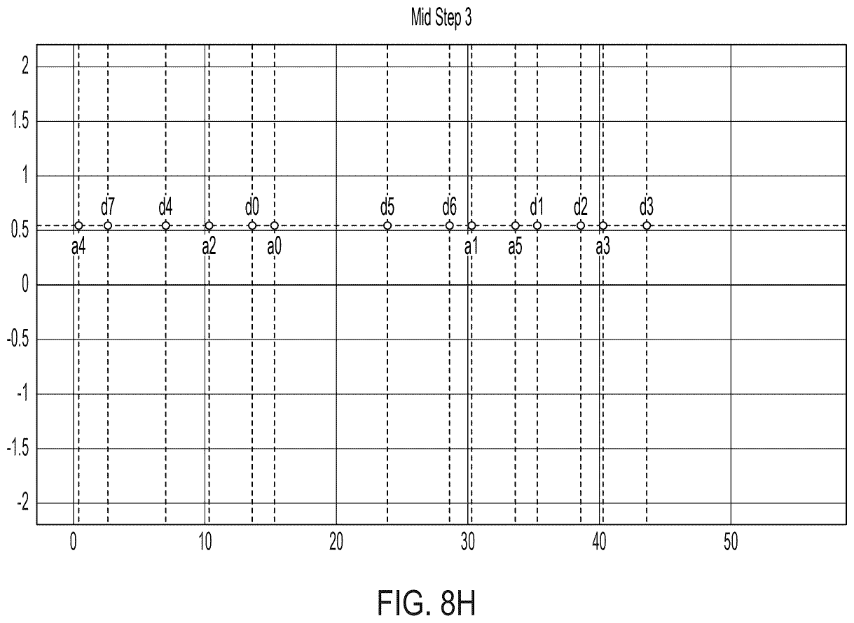

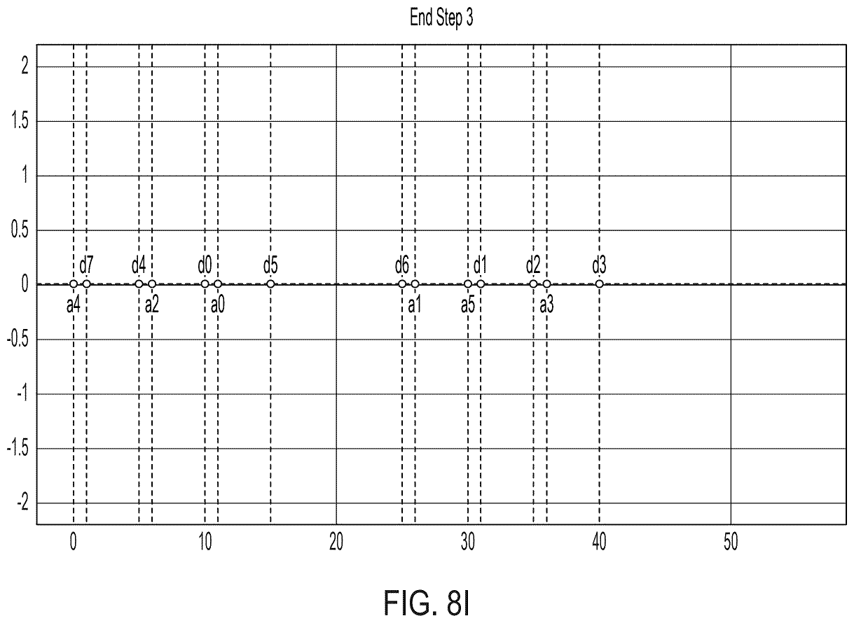

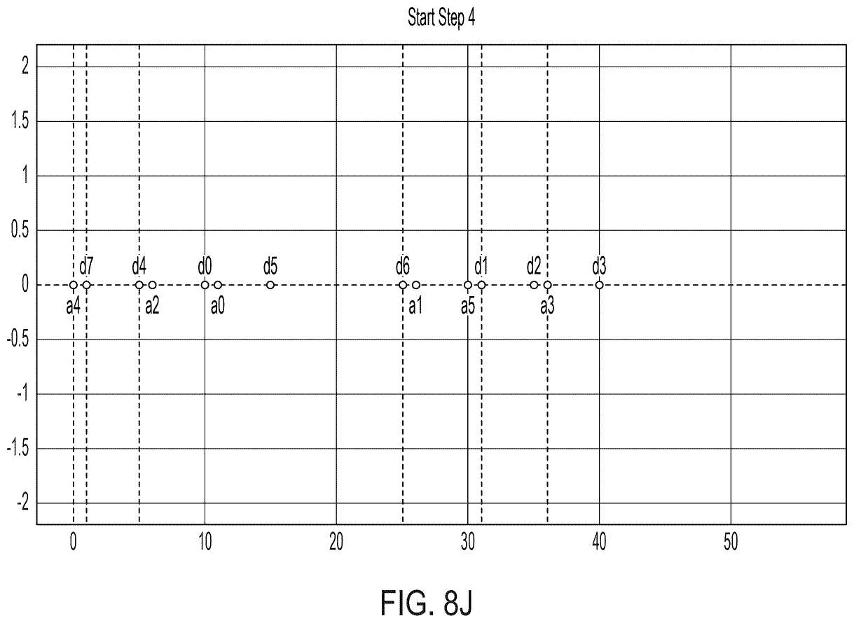

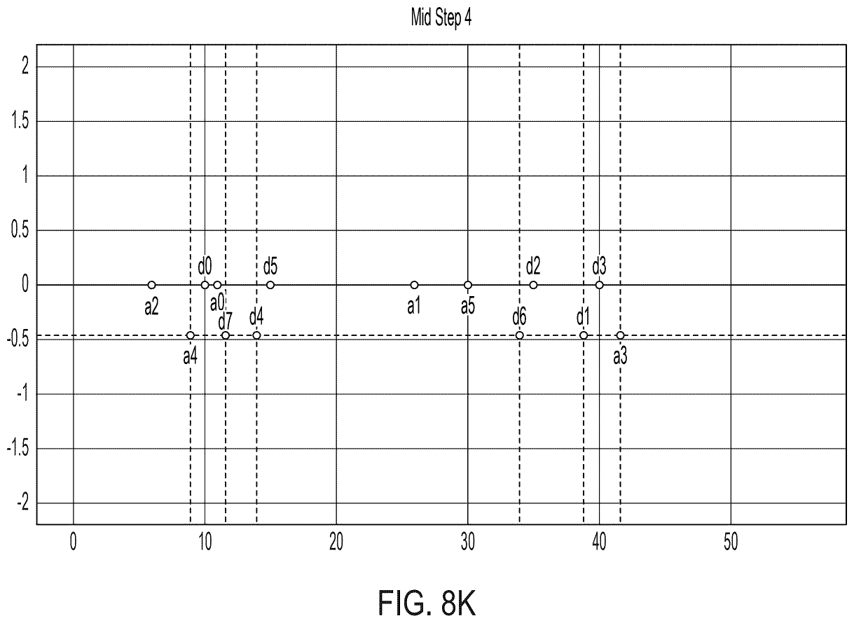

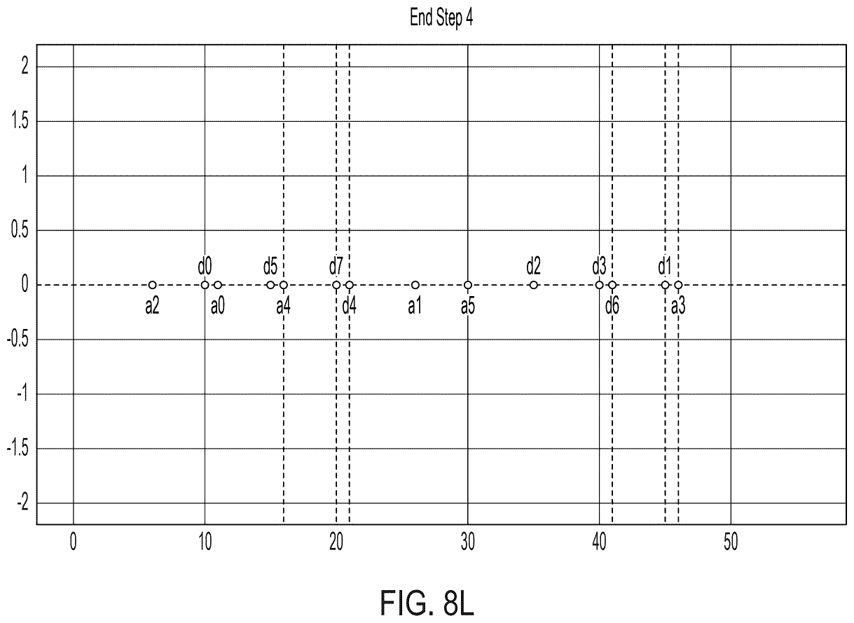

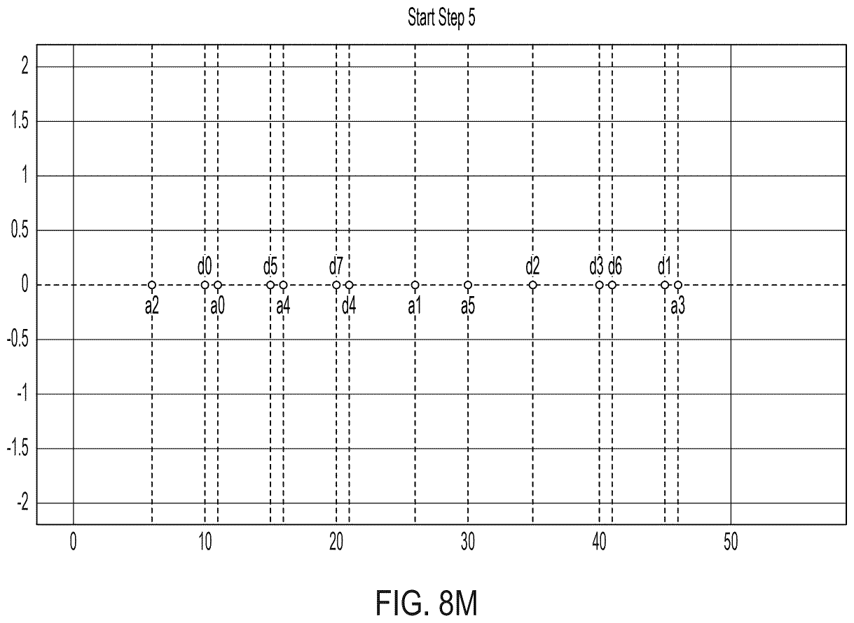

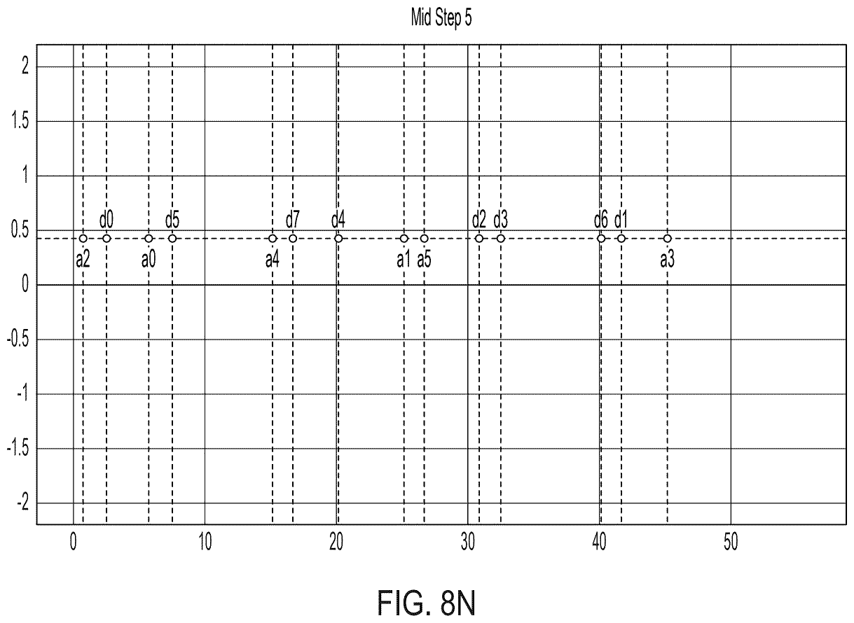

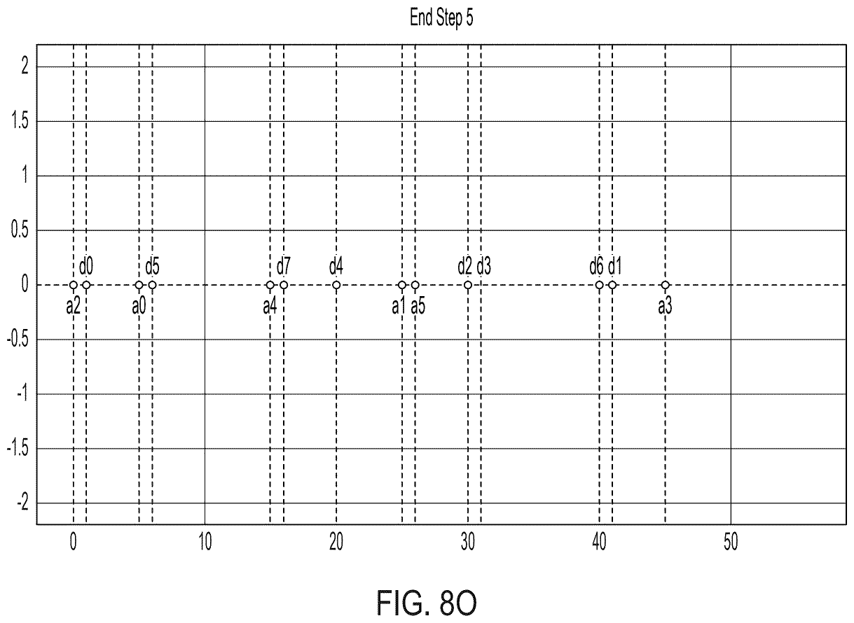

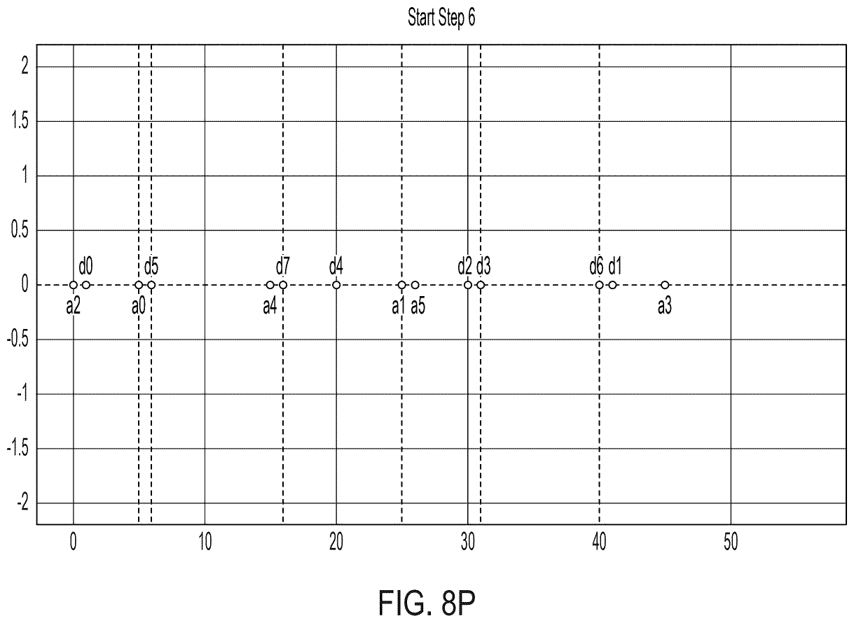

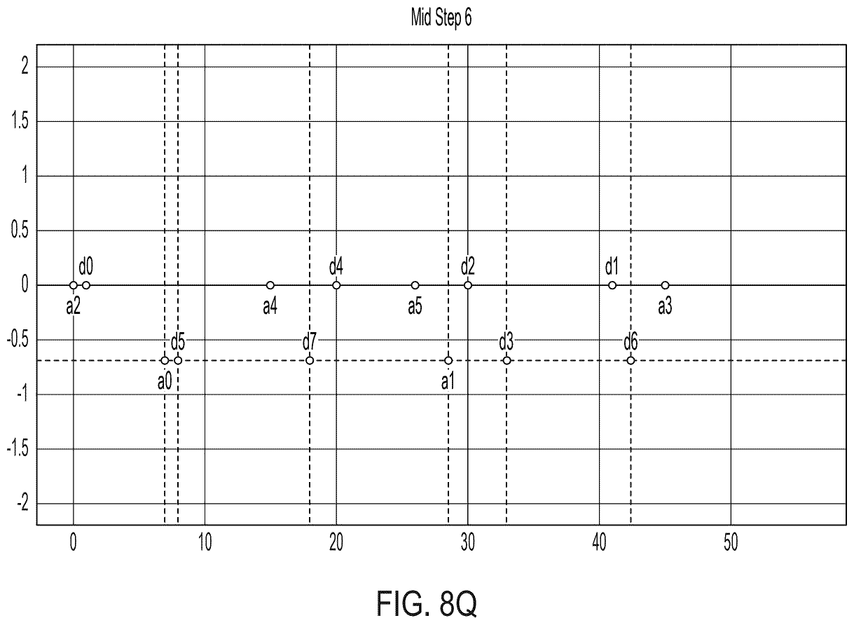

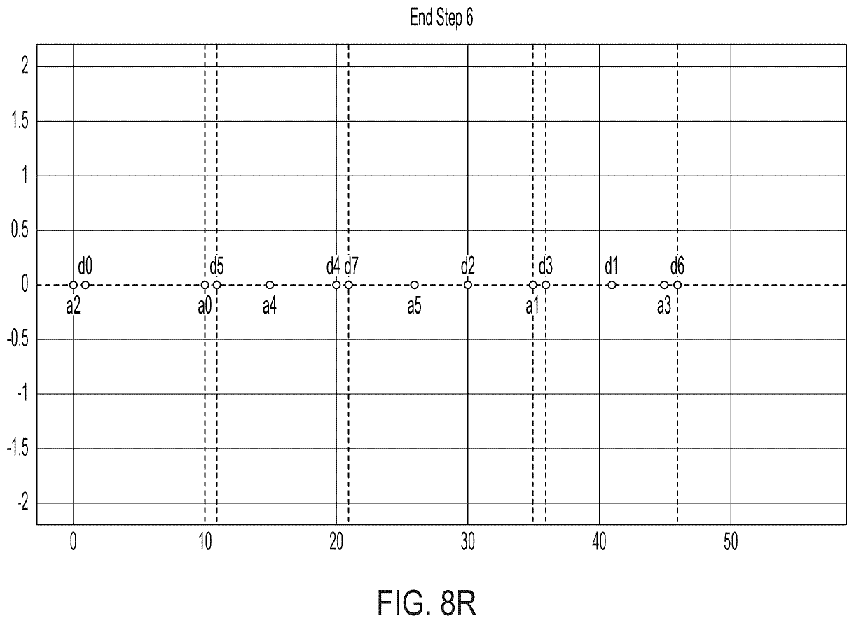

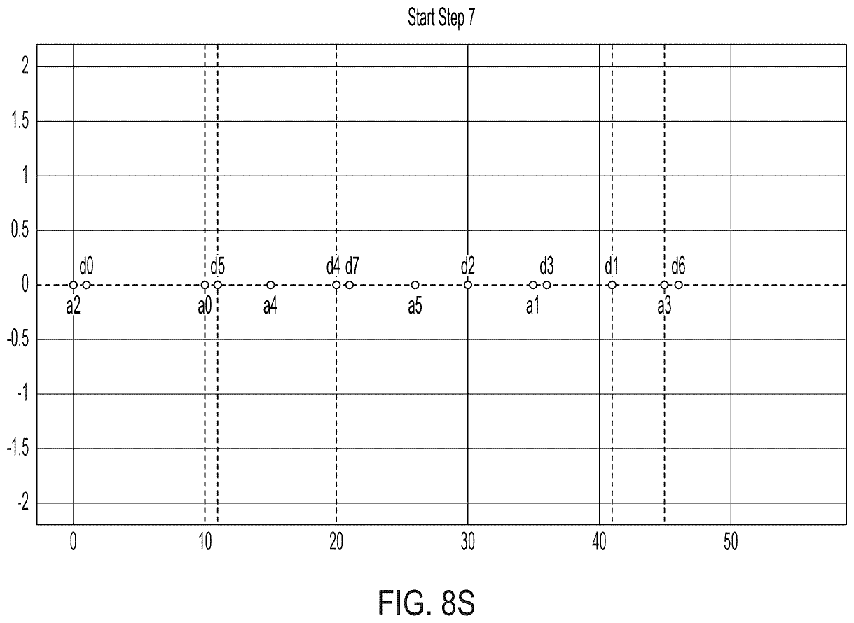

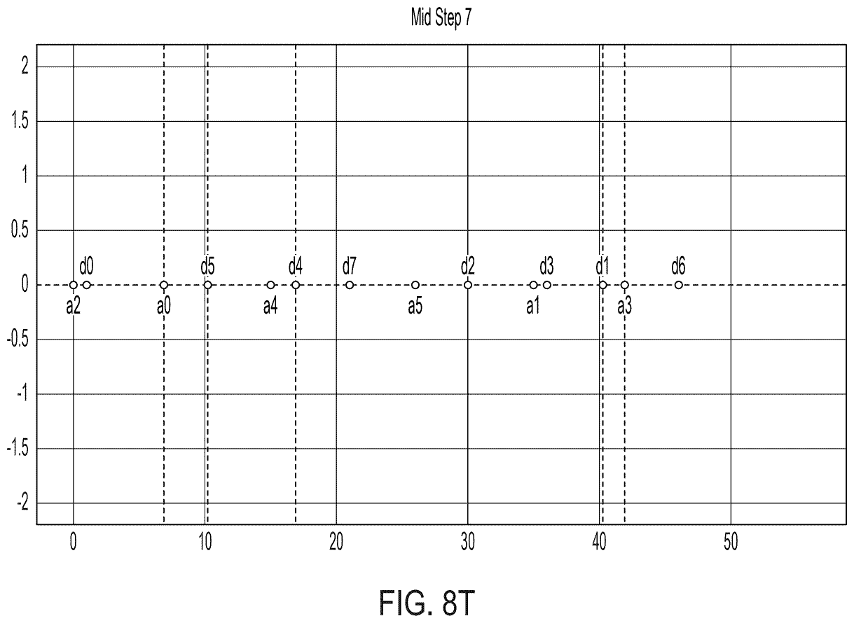

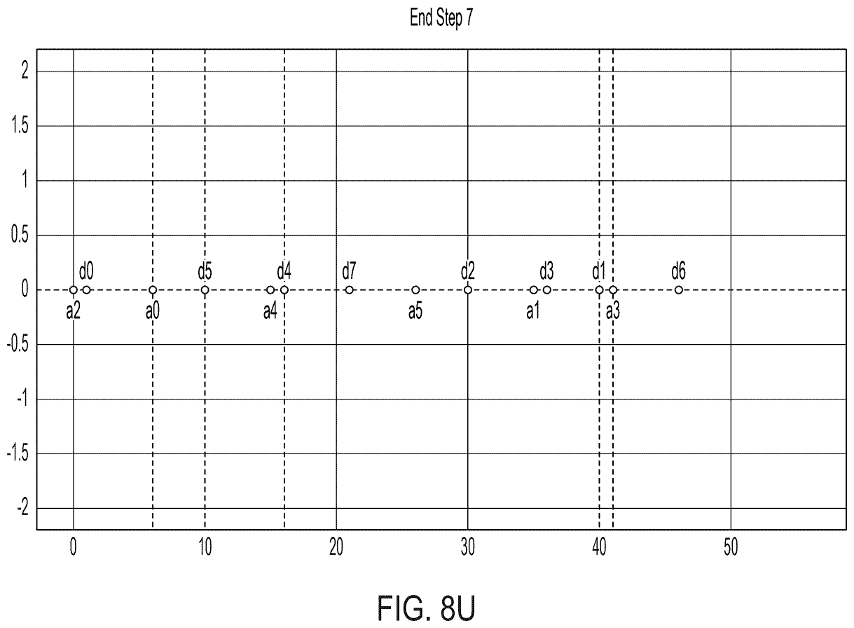

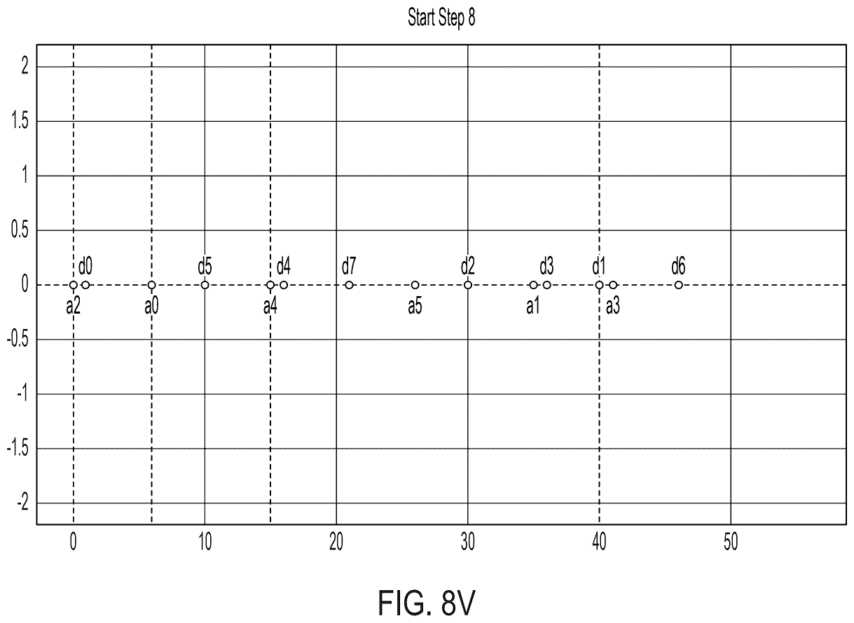

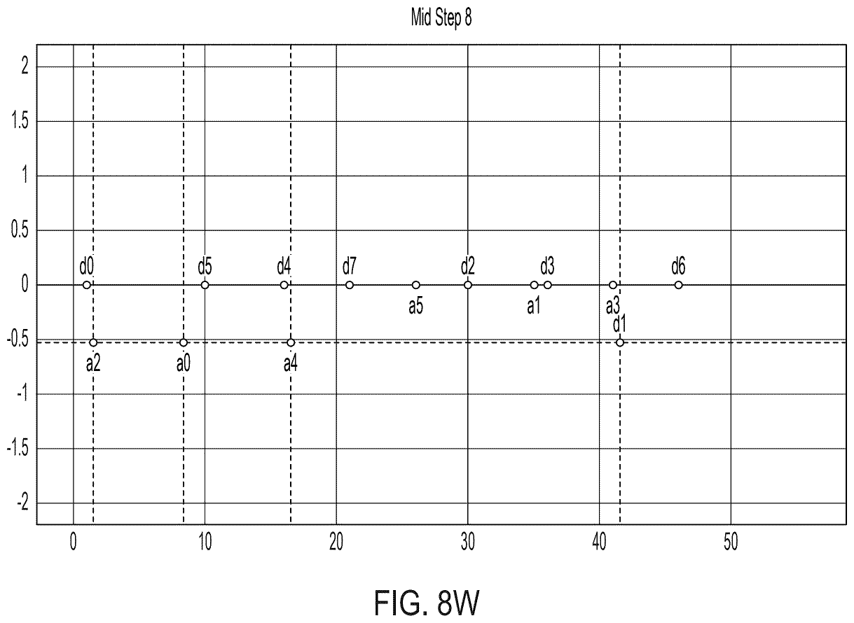

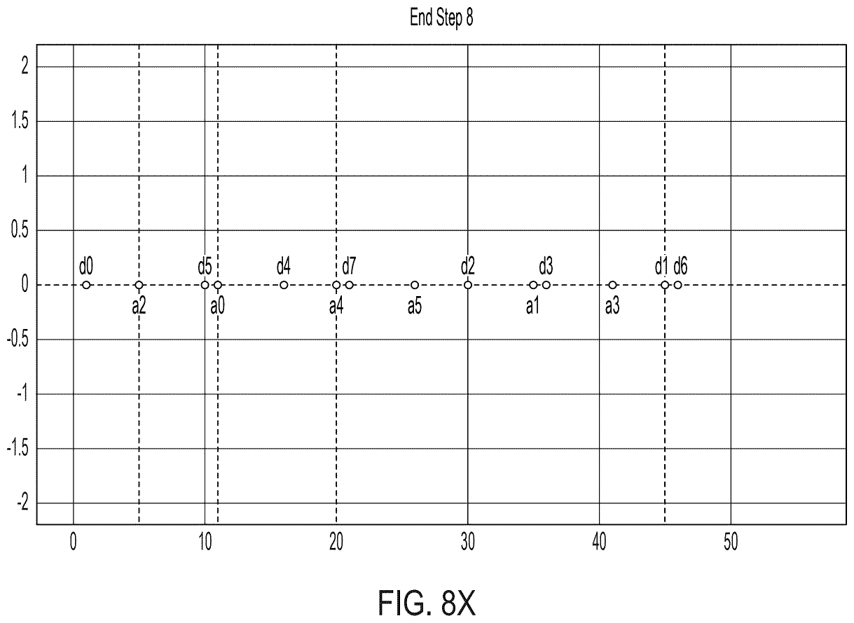

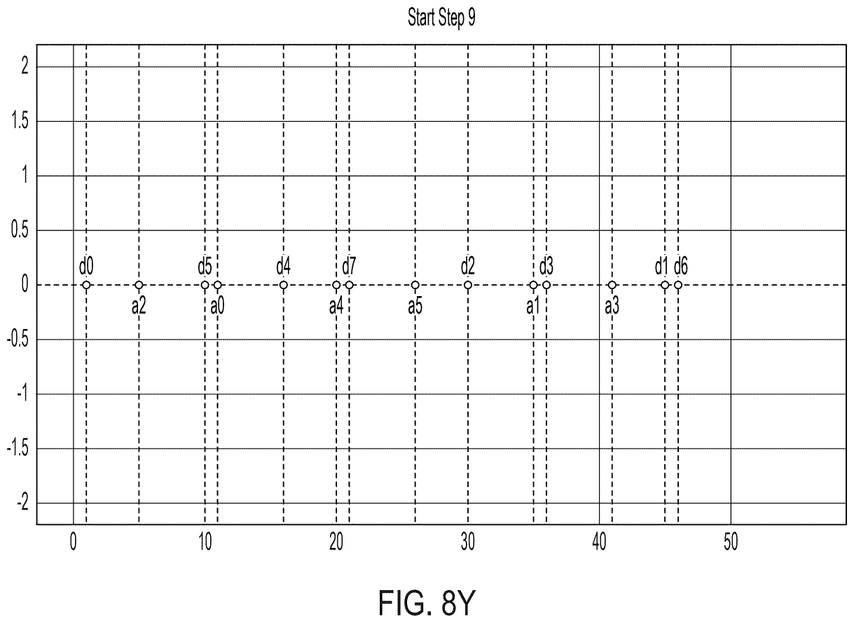

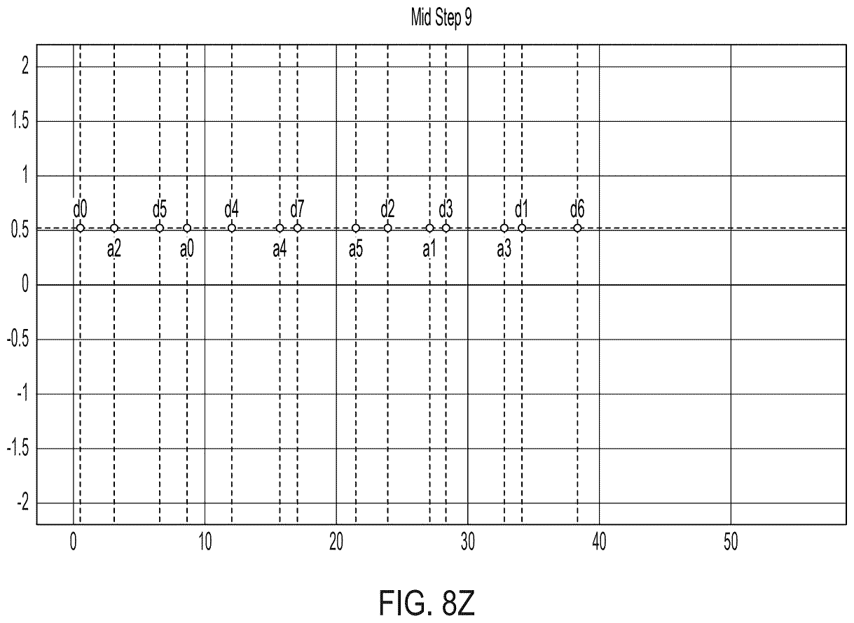

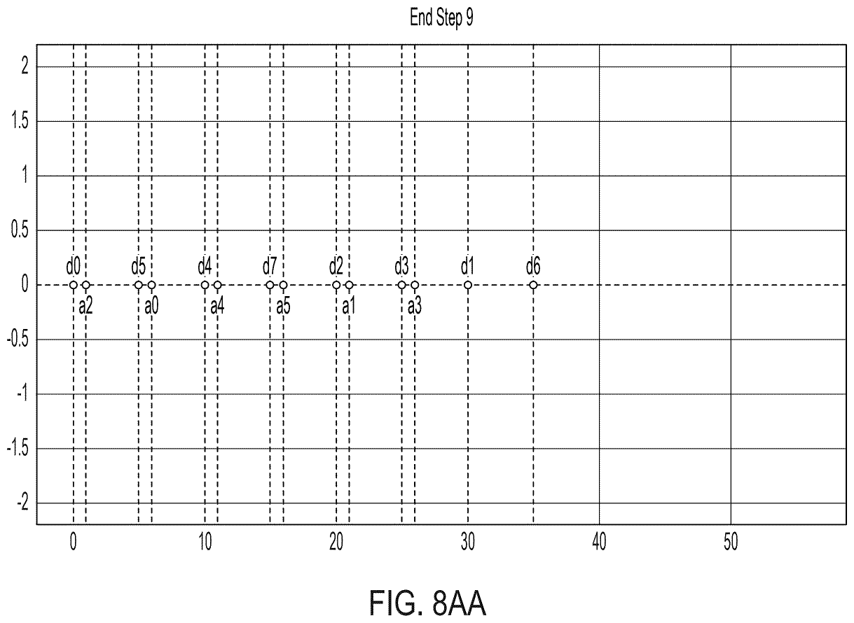

Referring to FIGS. 8A-AA, an exemplary 1-dimensional permutation is illustrated. In particular, each consecutive trio of images (e.g., FIGS. 8A, 8B, and SC) shows the start, midpoint, and end of each step of the permutation, with the qubits in motion highlighted with vertical dashed lines.

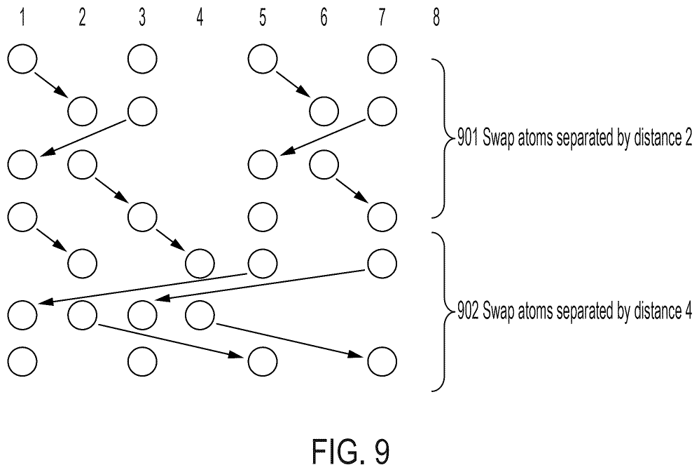

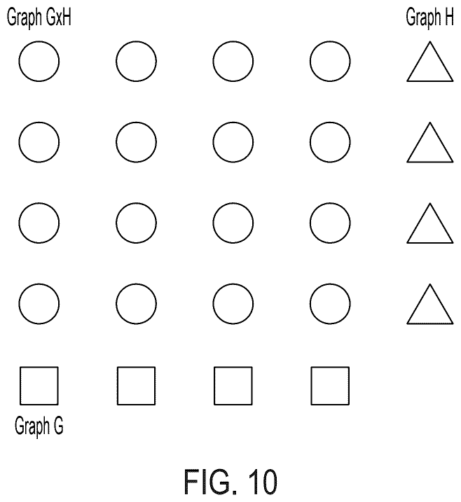

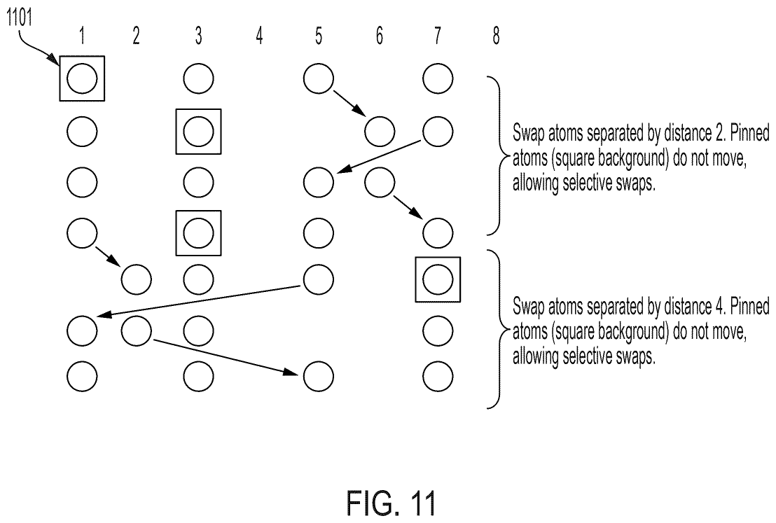

Referring to FIGS. 9-11, an additional algorithm is illustrated for arbitrary atom rearrangement in two dimensions. In FIG. 9, the parallel implementation of swap operations between atoms separated by 2^{k} is shown. In FIG. 10, a graph G×H generated by the product of two sub-graphs G and H is illustrated. In FIG. 11, the use of pinning beams (squares) to prevent movement in some columns is illustrated. By shining strong, local light spots, some of the atoms are prevented from moving under the parallel movement beam, allowing different rows to perform different permutations.

The algorithm involves three key components. First, it involves a technique for swapping all pairs of qubits separated by a distance 2^{k}, where k is an integer, using a number of extra workspace traps that is a constant factor of the total number of traps. Second, it uses the idea of extra fast switchable optical traps as pinning beams to allow different operations on different rows or columns. Third, it uses a routing algorithm that decomposes routing problems on a graph with a product structure into three steps on the individual components.

Pairs of qubits that are separated by a distance 2^{k} are swapped. By shining tweezer light on half of the atoms, corresponding to one atom of each pair of qubits separated by 2^{k}, one sublattice is picked up and moved to a temporary buffer location. The other half of the atoms is then picked up and moved to the original position of the first sublattice. Finally, moving the first sublattice from the temporary buffer location to the original position of the second sublattice completes the swap operation.

This process is illustrated in FIG. 9, where atoms separated by 2¹ positions are swapped in steps 901. Atoms separated by 2² positions are then swapped in steps 902.

As noted above, a routing algorithm is used that decomposes routing problems on a product graph into routing problems on subgraphs. One example of such an algorithm known in the art is described in Baumslag, M., Annexstein, F. A unified framework for off-line permutation routing in parallel networks. Math. Systems Theory 24, 233-251 (1991). https://doi.org/10.1007/BF02090401, which is hereby incorporated by reference. However, it will be appreciated that a variety of alternative algorithms may be employed provided that they meet the criteria set out above.

In order to perform routing on a product graph G×H (FIG. 10), routing is performed in each row based on the routing algorithm on graph G, followed by routing in each column based on the routing algorithm on graph H, and finally another round of row routing based on graph G. A key distinction from the more constrained moves for a hypergraph product code is that here, different rows or columns have to execute different movements.

Accordingly, local pinning beams that can be rapidly switched on and off are used to realize different movements in different columns or rows. As illustrated in FIG. 11, by shining pinning beams (shown as squares, e.g., 1101) on select atoms, certain atoms can be prevented from moving while still applying the same overall motion to all rows or columns. A pinning beam may be implemented by, e.g., a digital mirror device (DMD) that can be switched on a very fast timescale.

Comparing FIG. 9 and FIG. 11, one sees that pinning allows the implementation of swaps on only a selective set of qubit sites.

Putting all of these ingredients together provides a rearrangement algorithm that achieves an arbitrary 2D atom rearrangement in O(log N) depth, where N is the total number of qubits. First, the 2D atom rearrangement is decomposed into row, column, row permutations using the product routing algorithm described above. Then, the permutations within each row or column are implemented by combining swaps at distance 2^{k}, k=1,2, . . . , log L with local pinning beams.

An arbitrary 1D permutation can be implemented by O(log L) swaps by viewing it as a routing problem on a hypercube, and applying recursively the product routing algorithm. More specifically, routing on 2^{k} qubits can be achieved by viewing the 2^{k} qubits as a product of two graphs with 2^{k-1} qubits and 2 qubits, then routing on the 2-qubit graph, followed by the 2^{k-1} qubit graph, and then again on the 2-qubit graph. Local pinning beams allow performing different permutations in the different rows and/or columns. Accordingly, in some embodiments, the permutations are row- or column-specific rather than universal across all rows or columns.

While the above description uses a routing algorithm that decomposes routing problems on a product graph into routing problems on subgraphs described in Baumslag et al., cited above, alternative routing algorithms may be employed. For example, algorithms based on bitonic sorting, such as that described in Litinski, D., Nickerson, N. Active volume: An architecture for efficient fault-tolerant quantum computers with limited non-local connections. arXiv:2211.15465 [quant-ph](2022). https://doi.org/10.48550/arXiv.2211.15465, which is hereby incorporated by reference. This bitonic based sorting algorithm has complexity O(log²n).

The algorithms described herein, improve this complexity to O(log n) by exploiting the fact that unlike bitonic sorting networks, which require bit-wise comparison to determine where each element should go, the use cases herein have information about the target locations in advance.

In addition to the HGP codes described in other examples, the present disclosure may be used to implement lifted product (LP) codes.

LP codes are a modified version of the HGP codes. A quasi-cyclic LP code is obtained from two base protographs associated with two base matrices B₁ and B₂ over the quotient polynomial ring [symbol] [x]/(x^{l}−1). Suppose the two base matrices are of size m_{B}_{₁}×n_{B}_{₁} and m_{B}_{₂}×n_{B}_{₂}, respectively. One can obtain two matrices (over the same polynomial ring) Bₓ and B_{z} by taking the hypergraph product between B₁ and B₂:

$${B}_{x} = [ \begin{matrix}{B}_{1} ⊗ {I}_{{m}_{{B}_{2}}} & {I}_{{m}_{{B}_{1}}} ⊗ {B}_{2}\end{matrix} ] \qquad Equation 3$$

$${B}_{z} = [ \begin{matrix}{I}_{{n}_{{B}_{1}}} ⊗ {B}_{2}^{1} & {B}_{1}^{1} ⊗\end{matrix} {I}_{{n}_{{B}_{2}}} ]$$

Then, the X (Z) check matrix Hₓ (H_{z}) is obtained by replacing each entry of Bₓ (B_{z}) with its matrix representation with l by l circulant matrices, a process known as lift. The code size is

$$N = l ( {n}_{{B}_{1}} {n}_{{B}_{2}} + {m}_{{B}_{1}} {m}_{{B}_{2}} )$$

and the number of X and Z checks is

$${M}_{x} = {lm}_{{B}_{1}} {n}_{{B}_{2}}$$

and

$${M}_{z} = {ln}_{{B}_{1}} {m}_{{B}_{2}} ,$$

respectively. Assuming that Hₓ and H_{z} are full rank, then this yields a [symbol] N, N−M, d [symbol] −LP code.

The above construction can also be described using graphs. As an example, FIG. 12 shows a LP code using a 3 by 5 protograph and a lift size 2. The LP code is constructed by taking a lift over the hypergraph product of two classical protographs. The protographs and their hypergraph product are indicated by the dashed nodes (e.g., 1201) and the lift is illustrated by the multiple inner nodes within each dashed node (e.g., 1202, 1203). The inner connectivity between two dashed nodes is given by the matrix representation of the ring elements in Equation 3. When flattening the inner nodes vertically (horizontally), the vertical (horizontal) connectivity between the qubits and the checks for each column (row) is the same as the left 1204 (top 1205) lifted classical code.

An i-th dashed check node is connected to the j-th dashed variable node if Bᵢⱼ (B:=B₁=B₂) is non-zero. A lift of the protograph is done by replacing each dashed node with its two inner solid nodes, and setting up the connectivity between the inner nodes according to the matrix representation of each ring element Bᵢⱼ. Equation 3 corresponds to taking the hypergraph product between the protograph and itself, obtaining a grid of dashed nodes. Similar to the hypergraph product code, the connectivity between the dashed nodes (the entries of Bₓ and B_{z}) is inherited from B₁ and B₂. Then the qubits and the quantum checks are given by the inner nodes after the lift, and their connectivity is given by the matrix representation of Bₓ and B_{z}. An important feature of the LP codes is that they still have some remaining product structure even after the lift. As shown in FIG. 12, when flattening the inner nodes vertically (horizontally), the vertical (horizontal) connectivity between the qubits and the checks for each column (row) is the same as the left (top) lifted classical code.

For a matrix entry over the polynomial ring, its weight is denoted as its number of terms. For the LP codes constructed in this disclosure, a base matrix is chosen with all weight-one entries of dimension 3 by 5 and a family of codes is obtained with sizes up to 1428 by increasing the shift-lift size l. The classical parity checks constructed are optimized by choosing the base matrix entries over the quotient polynomial ring to obtain the best minimum distance for the particular shift-lift size l. The choice of the base matrix entries is also such that the girth (length of the shortest cycle in the Tanner graph) is at least 8, and the minimum distances of the lifted product qLDPC codes are the same as the designed classical minimum distances. Note that the choice of the base weight matrix determines the bounds on the best possible minimum distance for such code construction. Allowing multiple weights and more general protographs give more flexibility in qLDPC code design and improve their minimum distances.

Referring back to Equation 2, time overheads for LP codes may be estimated as follows.

For LP codes, one needs to first flatten the code layout before implementing the parallel rearrangement scheme. For a fixed 3 by 5 protograph, the flattened rectangle array has dimensions of 2n/8 by 8. This can be achieved in log depth using a divide-and-conquer algorithm that flattens the code by half each time. For example, as shown in FIG. 12, the codes are flattened vertically before establishing vertical connections between atoms via row permutations. The vertical connectivity is then the same as an HGP code, and one can use the efficient 1D rearrangement scheme described earlier. Therefore, the rearrangement time for LP codes is estimated by setting L to n/8 in Equation 2.

The rearrangement time in Equation 2 determines the idling errors between sequences of entangling gates in a syndrome extraction circuit. In general, t_{rearrange}(n) is a function of the code size n, as L is a function of n. Assuming the idling errors pᵢ(n) can also improve as the gate error p_{g} improves:

$${p}_{i} ( n ) = \frac{{t}_{rearrange} ( n )}{{T}_{c}} \times \frac{{p}_{g}}{0.005} \qquad Equation 4$$

where the coherence time T_{c} and other constant parameters in t_{rearrange}(n) are listed above.

### Exemplary Methods

### Code Constructions

The following section focuses on two families of qLDPC codes, although it will be appreciated that these results may be extended to asymptotically good codes.

The first family of codes are hypergraph product (HGP) codes, formed from the product of two classical LDPC codes. A geometric sketch of the code properties is provided above, and the following discussion focuses on an alternative algebraic description of the codes and provides more details of their code properties. Algebraically, if the parity check matrix (where rows describe bits that should sum to an even number in the absence of errors) of the two underlying classical codes are given as

$${H}_{1} ∈ {𝔽}_{2}^{{r}_{1} \times {n}_{1}} ,$$

$${H}_{2} ∈ {𝔽}_{2}^{{r}_{2} \times {n}_{2}} ,$$

then the X and Z stabilizer check matrices for the HGP code can be written as

$${H}_{x} = ( \begin{matrix}{H}_{1} ⊗ {I}_{{n}_{2}} & {I}_{{r}_{1}} ⊗ {H}_{2}^{T} )\end{matrix} \qquad Equation 5$$

$${H}_{z} = ( \begin{matrix}{I}_{{n}_{1}} ⊗ {H}_{2} & {H}_{1}^{T} ⊗ {I}_{{r}_{2}}\end{matrix} ) \qquad Equation 6$$

For classical [nᵢ, kᵢ, dᵢ] linear codes defined by rᵢ=nᵢ−kᵢ linearly-independent checks (i=1,2), the resulting quantum code has parameters [symbol] n₁n₂+r₁r₂, k₁k₂, min{d₁, d₂} [symbol] . The surface code is a special case of hypergraph product codes, with the classical codes being 1D repetition codes. However, by instead choosing classical codes with good vertex expansion as the underlying classical codes, where kᵢ=Θ(nᵢ), dᵢ=Θ(nᵢ), the resulting quantum code (known as a quantum expander code) encodes a linear number of logical qubits k=Θ(n) and has distance d=Θ(\sqrt{n}). Such classical expander codes can be obtained asymptotically, for example, from random biregular Tanner graphs, and will have sufficient vertex expansion with high probability. Logical operators are inherited from the underlying classical code, and one can choose a basis such that each logical qubit has support in only a single row or column.

In this disclosure, HGP codes are constructed by taking the hypergraph product of classical LDPC codes defined by (3,4)-regular Tanner graphs, i.e., bipartite graphs with degree-3 bit nodes and degree-4 check nodes. By increasing the size of the graph, a family of HGP codes is obtained with a constant encoding rate

$$\frac{k}{n} \geq 0.04 .$$

For each code size, the classical code is selected having the largest distance, Tanner graph girth larger than 6 (length of the shortest cycle in the Tanner graph, obtained through rejection sampling without performing edge swaps), and the largest spectral gap (the gap between the largest two singular values of the check matrices) from randomly generated instances. The hypergraph product of vertex-expanding classical codes yields HGP codes that satisfy the syndrome confinement property, and support single-shot QEC.

The second family of codes considered are quasi-cyclic lifted product (LP) codes, which can be viewed as a hypergraph product code followed by a symmetry reduction to reduce the number of required qubits. Algebraically, a quasi-cyclic LP code is obtained from two base protographs (analogs of the classical codes in the HGP construction) associated with two base matrices B₁ and B₂ over the quotient polynomial ring

$$\frac{ℝ [ x ]}{{x}^{l} - 1} .$$

Suppose two base matrices are of size m_{B}_{₁}×n_{B}_{₁} and m_{B}_{₂}×n_{B}_{₂}, respectively. Two matrices are obtained (over the same polynomial ring) Bₓ and B_{z} by taking the hypergraph product:

$${B}_{x} = [ \begin{matrix}{B}_{1} ⊗ {I}_{{m}_{{B}_{2}}} & {I}_{{m}_{{B}_{1}}} ⊗ {B}_{2}^{T}\end{matrix} ] \qquad Equation 7$$

$${B}_{z} = [ \begin{matrix}{I}_{{n}_{{B}_{1}}} ⊗ {B}_{2} & {B}_{1}^{T} ⊗\end{matrix} {I}_{{n}_{{B}_{2}}} ] .$$

The X (Z) check matrix Hₓ (H_{z}) is then obtained by replacing each entry of Bₓ (B_{z}) with its matrix representation as l by l circulant matrices, a process known as a lift. The code size is

$$N = l ( {n}_{{B}_{1}} {n}_{{B}_{2}} + {m}_{{B}_{1}} {m}_{{B}_{2}} )$$

and the number of X and Z checks are

$${M}_{x} = {lm}_{{B}_{1}} {n}_{{B}_{2}} and {M}_{z} = {ln}_{{B}_{1}} {m}_{{B}_{2}} ,$$

respectively. The encoding rate is lower bounded by

$$\frac{( N - {M}_{x} - {M}_{z} )}{N} = \frac{( {n}_{{B}_{1}} {n}_{{B}_{2}} + {m}_{{B}_{1}} {m}_{{B}_{2}} - {m}_{{B}_{1}} {n}_{{B}_{2}} - {n}_{{B}_{1}} {m}_{{B}_{2}} )}{{n}_{{B}_{1}} {n}_{{B}_{2}} + {m}_{{B}_{1}} {m}_{{B}_{2}}} .$$

One can also describe the above construction using graphs. As an example, FIG. 12 shows a LP code using a 3 by 5 protograph associated with a base matrix

$$B ∈ {\{ \frac{ℝ [ x ]}{{x}^{2} - 1} \}}^{3 \times 5} .$$

The checks and bits of the protograph are illustrated by the big dashed nodes. The i-th dashed check node is connected to the j-th dashed bit node if Bᵢⱼ is non-zero. A lift of the protograph is done by replacing each dashed node with its two inner solid nodes, and setting up the connectivity between the inner nodes according to the matrix representation of each ring element Bᵢⱼ. Equation 7 corresponds to taking the hypergraph product between the protograph and itself, obtaining a grid of dashed nodes. Similar to the hypergraph product code, the connectivity between the dashed nodes (the entries of Bₓ and B_{z}) is inherited from B. Then the qubits and the quantum checks are given by the inner nodes after the lift, and their connectivity is given by the matrix representation of Bₓ and B_{z}. An important feature of the LP codes is that they still have some remaining product structure even after the lift. As shown in FIG. 12, when flattening the inner nodes vertically (horizontally), the vertical (horizontal) connectivity between the qubits and the checks for each column (row) is the same as the left (top) lifted classical code.

For the LP codes constructed in this disclosure, a base matrix of dimension 3 by 5 is chosen, where all entries have a single polynomial term, and a family of codes is obtained with sizes up to 1428 by increasing the lift size l from 16 to 42. The classical parity checks are optimized by choosing the base matrix entries over the quotient polynomial ring to obtain the best classical distance for the particular lift size 1. The choice of the base matrix entries is also such that the girth is at least 8, and the distances of the lifted qLDPC codes match the designed classical distances with a high probability. Allowing multiple polynomial terms for each base matrix entry and more protographs of different sizes gives more flexibility in qLDPC code design and improves their distances. The classical base matrices used to construct the four LP codes used in this example are provided below. Denoting

$${B}_{d}^{l}$$

as a base matrix with a lift size l and a classical code distance d after the lift, the base matrices are

$${B}_{12}^{16} = [ \begin{matrix}1 & 1 & 1 & 1 & 1 \\ 1 & {x}^{2} & {x}^{4} & {x}^{7} & {x}^{11} \\ 1 & {x}^{3} & {x}^{10} & {x}^{14} & {x}^{15}\end{matrix} ] , {B}_{16}^{21} = [ \begin{matrix}1 & 1 & 1 & 1 & 1 \\ 1 & {x}^{4} & {x}^{5} & {x}^{7} & {x}^{17} \\ 1 & {x}^{14} & {x}^{18} & {x}^{12} & {x}^{11}\end{matrix} ] \qquad Equation 8$$

$${B}_{20}^{30} = [ \begin{matrix}1 & 1 & 1 & 1 & 1 \\ 1 & {x}^{2} & {x}^{14} & {x}^{24} & {x}^{25} \\ 1 & {x}^{16} & {x}^{11} & {x}^{14} & {x}^{13}\end{matrix} ] , {B}_{24}^{42} = [ \begin{matrix}1 & 1 & 1 & 1 & 1 \\ 1 & {x}^{6} & {x}^{7} & {x}^{9} & {x}^{30} \\ 1 & {x}^{40} & {x}^{15} & {x}^{31} & {x}^{35}\end{matrix} ] \qquad Equation 9$$

The quantum code distances are upper bounded by the classical code distances of the above (lifted) base matrices. After extensive search for minimum-weight logical operators using a GAP package, these upper bounds appear to be tight.

### Atom Rearrangement Algorithm

The reconfigurable atom array platform features efficient, parallel control and rearrangement of large numbers of qubits, enabling the implementation of long-range connected quantum processors. As discussed herein, optical tools such as crossed acousto-optic deflectors (AODs) can generate a rectangular grid of optical tweezers that can be reconfigured on the fly, allowing the control of large code blocks consisting of thousands of physical qubits with only a handful of classical controls.

However, the use of AODs for dynamic rearrangement comes with two key constraints. First, as the X and Y direction optical spots are controlled by separate AODs, the same operation needs to be applied across multiple rows and/or columns. Second, different rows of atoms cannot cross each other due to beating between RF tones and atom collisions, although they can be temporarily transferred and stored in static traps, such as those based on spatial light modulators (SLMs). Thus, the implementation of qLDPC codes with improved code parameters (number of encoded qubits, code distance), which often relies on pseudorandom expander graphs with complex connectivity graphs, requires the development of efficient atom rearrangement algorithms.

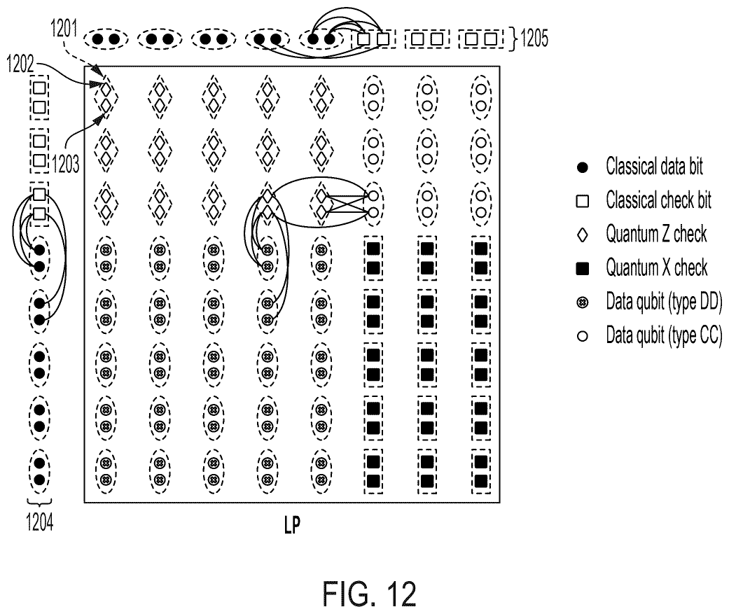

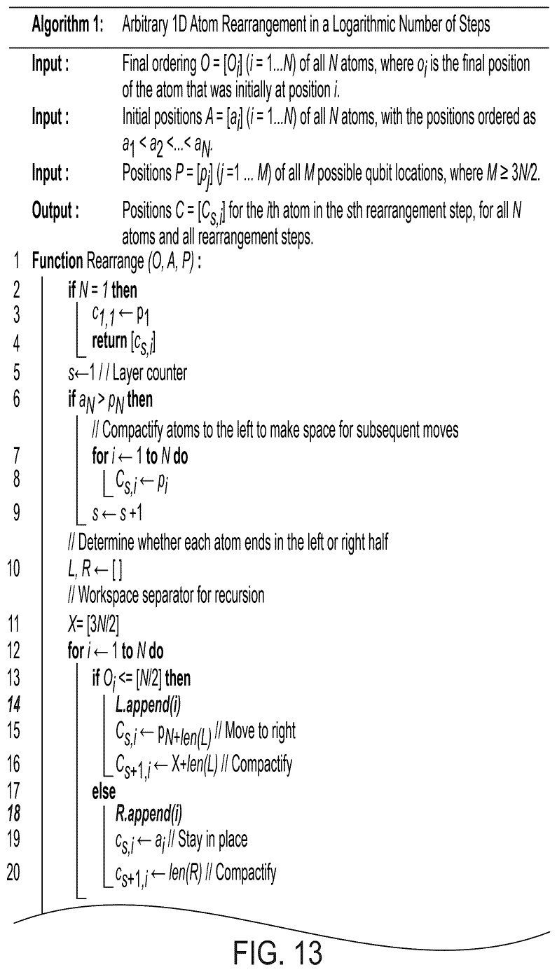

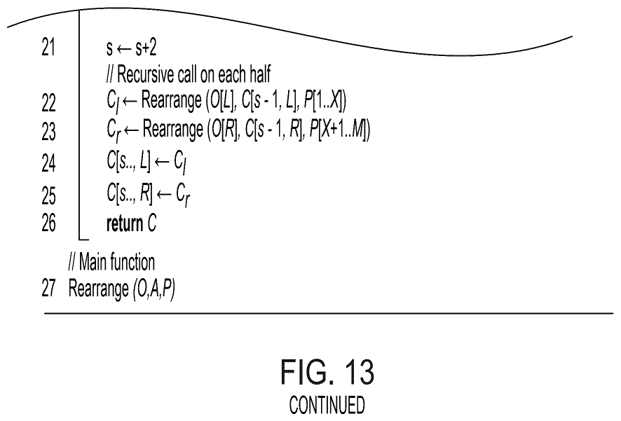

FIGS. 13-15 provide a detailed description of an atom rearrangement algorithm in the form of Algorithms 1-3.

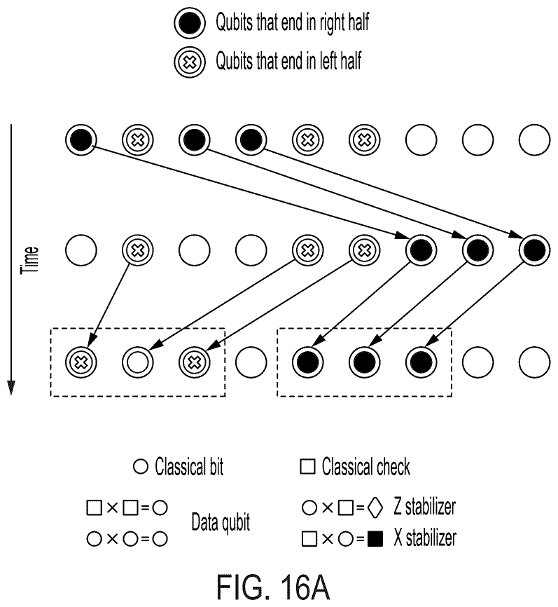

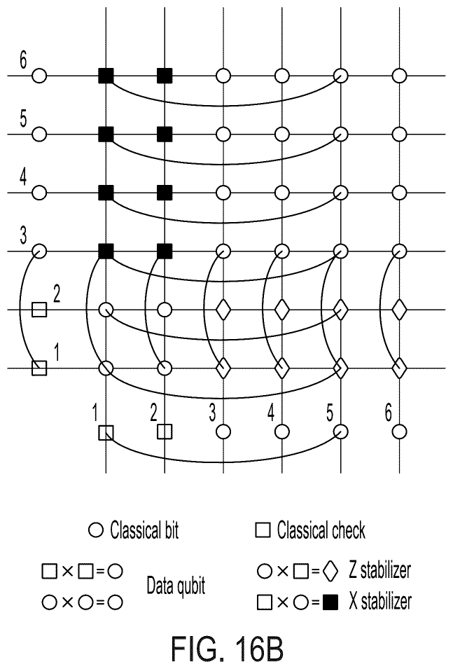

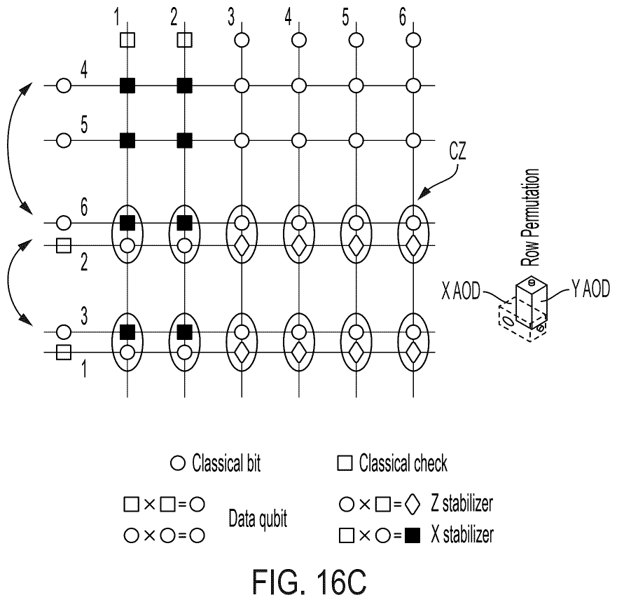

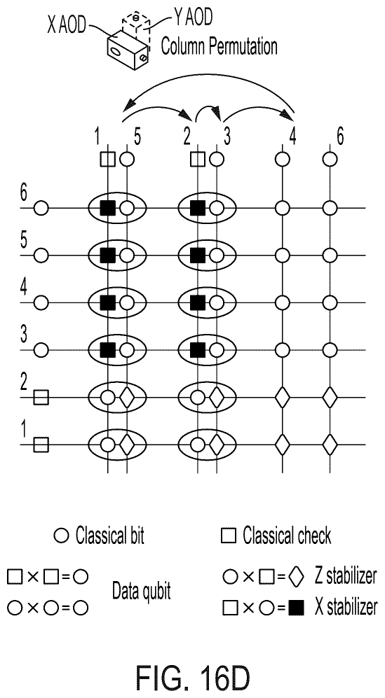

The first component, arbitrary 1D atom rearrangements with a number of steps that scales logarithmically, is described in detail in Algorithm 1, illustrated in FIGS. 16A-D, and explicitly worked out for a small example in FIG. 7. Since successive layers each reduce the system size by half, the total number of layers required to achieve the desired rearrangement is ┌log₂ L┐. Thus, arbitrary rearrangements in very large systems can be achieved in a small number of layers. Although this method shares some similarities to techniques such as bitonic sorting, the different constraints (comparators vs. parallel moves) lead to differences in the algorithm itself. The algorithm can also be applied to use parallel qubit swaps at increasing distances as the basic primitive, with the same O(log L) scaling with system size.

FIGS. 16A-D illustrate the efficient implementation of quantum LDPC codes with atom arrays. FIG. 16A is an illustration of an algorithm to perform an arbitrary log-depth rearrangement. First, all atoms that need to end in the right half of the system are moved to the right side, then each half is compacted into adjacent sites, so that there is sufficient workspace for subsequent steps. The same procedure can then be repeated on each half of the system recursively for depth log(L), where L is the length of the atom array to be rearranged. FIG. 16B is an illustration of the HGP code, obtained as a product of two classical codes. Lines indicate that the parity check at the syndrome node involves the corresponding data node. FIGS. 16C-D show the required connectivity implemented via parallel row permutations, followed by parallel column permutations.

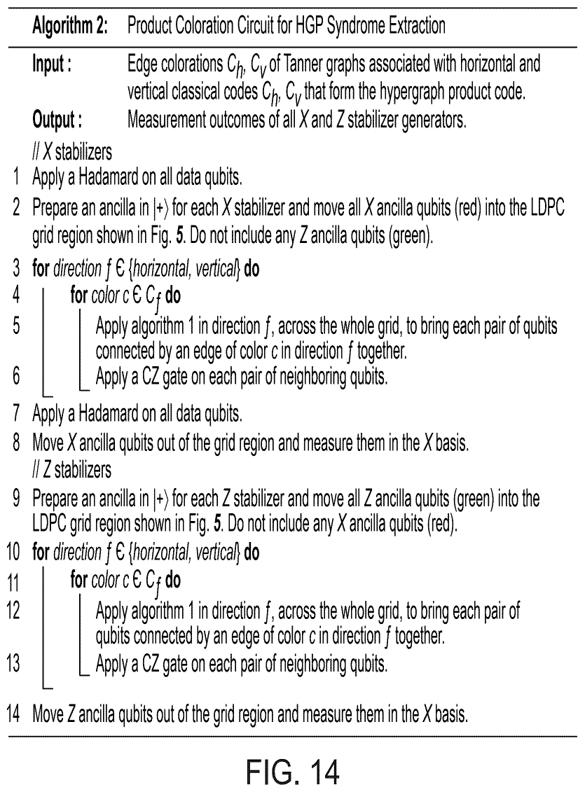

The second component is the observation that the product structure of crossed AODs matches well with the product structure present in many qLDPC codes. Details of a syndrome extraction circuit for HGP codes are provided, based on this observation, in Algorithm 2 (FIG. 14), which is referred to as the product coloration circuit, as it makes use of coloration circuits for each of the component classical codes. The use of the product coloration circuit, as opposed to alternative coloration or cardinal circuits, is necessary to fully exploit the parallel rearrangement capabilities across rows and columns. Here, the native entangling gate set of current atom array systems is diagonal, so CZ gates and appropriate Hadamard rotations are used to perform syndrome extraction. Under global laser excitation and phase advances, any pair of qubits that are within a certain radius (known as the blockade radius) of each other will execute a CZ gate, while any individual qubits will undergo an identity gate. In order to analyze these results, CNOT gates are used as the entangling gates in the simulations. This can be physically justified if the CZ gates are much noisier than the Hadamard gates.

The product coloration circuit separately extracts the X and Z syndromes, each requiring both a horizontal and vertical step. Thus, if the coloration of each of the classical codes involves Δ_{c} colors (for the codes constructed from (3,4)-biregular graphs that are considered herein, Δ_{c}=4, the product coloration circuit will have 4Δ_{c} entangling layers.

The product coloration circuit can also be applied to the LP codes used herein. As shown in FIG. 12, a LP code has the same product vertical (horizontal) connectivity as a HGP code when flattening the inner nodes vertically (horizontally). Thus, the same product coloration circuit can be applied to the LP codes with an extra step of flattening the inner codes in between establishing the horizontal/vertical connections. As 3 by 5 base matrices are used with all weight-one entries, the product coloration circuit for the LP codes has an entangling gate depth of 4×5=20.

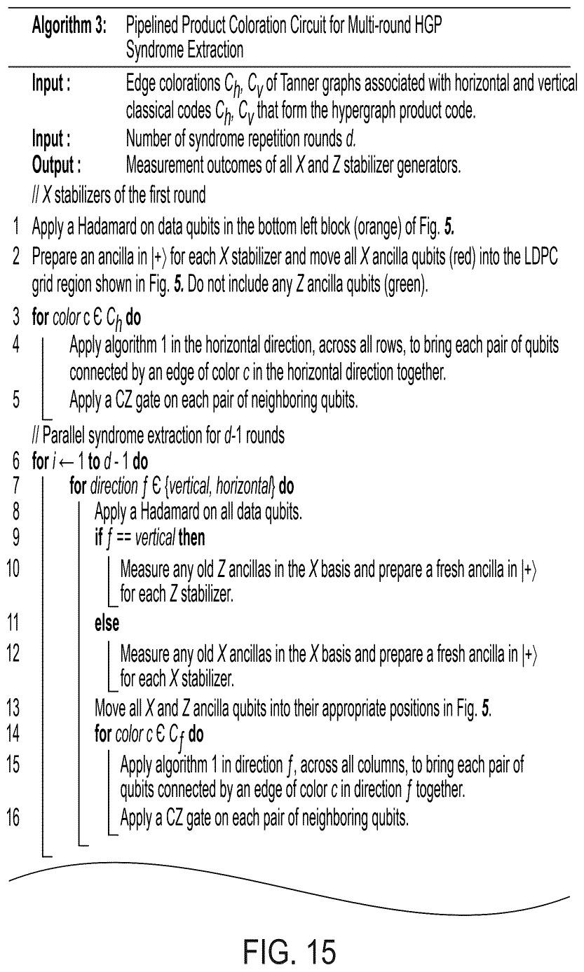

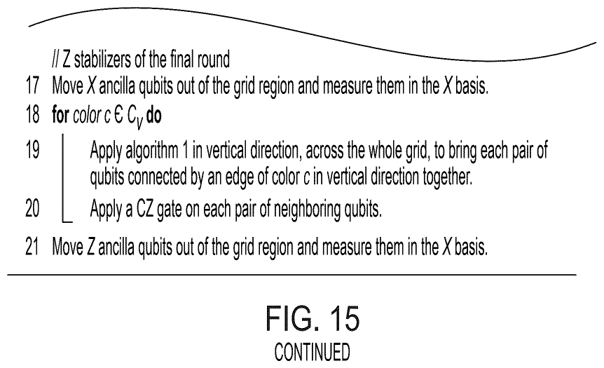

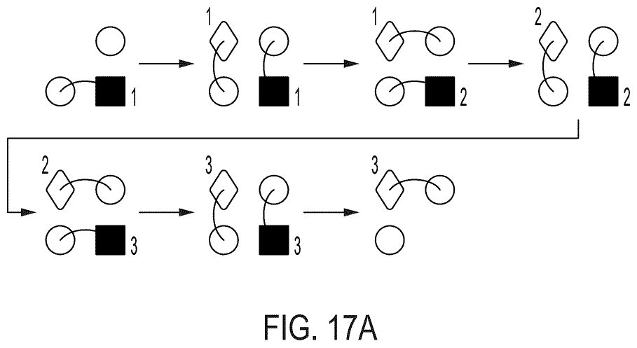

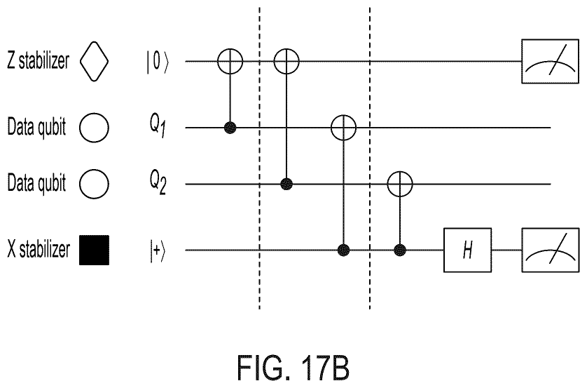

To further reduce the depth of the syndrome extraction circuit, a modification of the above circuit is provided in Algorithm 3 (FIG. 15) and FIGS. 17A-B, which is referred to as the pipelined product coloration circuit. Here, the main challenge is to choose a gate ordering such that the desired X and Z syndromes are correctly extracted. By performing pipelining and extracting the X syndrome of the second round simultaneously with the Z syndrome of the first round, one can ensure that the gate ordering is always valid, while reducing the number of entangling layers required to perform d rounds of syndrome measurement to (2d+2)Δ_{c}. This could be particularly relevant in further suppressing the effect of idling errors as well as improving the performance of logical gates, which in this scheme require d rounds of repetition.

Referring to FIGS. 17A-B, ordering of operations in pipelined syndrome extraction is illustrated. In FIG. 17A, successive steps of entangling gates for the pipelined product coloration circuit described in Algorithm 3 are shown, with d=3 rounds of syndrome extraction. Numbers at the corners of the X and Z ancilla qubits denote the round of syndrome extraction they correspond to. FIG. 17B is an illustration of a local circuit that data qubits and ancilla qubits of the same round see, with dashed lines indicating different circuit moments. As the X stabilizer interacts with both qubits before the Z stabilizer, the syndrome extraction order is valid. Similar analysis can be performed for the commutation relations with the next round of ancilla qubits.

### Dynamic Reconfiguration in 2D Tweezer Arrays

Exemplary experiments utilize the apparatus described below. Inside the vacuum cell, ⁸⁷Rb atoms are loaded from a magneto-optical trap into a backbone array of programmable optical tweezers generated by a spatial light modulator (SLM). Atoms are rearranged in parallel into defect-free target positions in this SLM backbone by additional optical tweezers generated from a crossed 2D acousto-optic deflector (AOD). Following the rearrangement procedure, selected atoms are transferred from the static SLM traps back into the mobile AOD traps, and then these mobile atoms are moved to their starting positions in the quantum circuit. During this entire process, the atoms are cooled with polarization gradient cooling. Before running the quantum circuit, a camera image of the atoms in their initial starting positions is taken. Following the circuit, a final camera image is taken to detect qubit states |0 [symbol] (atom presence) and |1 [symbol] (atom loss, following resonant pushout). All data are postselected on finding perfect rearrangement of the AOD and SLM atoms before running the circuit. In some embodiments, each atom remains in a single static or single mobile trap throughout the duration of the quantum circuit.

The crossed AOD system is composed of two independently controlled AODs (AA Opto Electronic DTSX-400) for x and y control of the beam positions. Both AODs are driven by independent arbitrary waveforms which are generated by a dual-channel arbitrary waveform generator (AWG) (M4i.6631-x8 by Spectrum Instrumentation) and then amplified through independent MW amplifiers (Minicircuits ZHL-5W-1). The time-domain arbitrary waveforms are composed of multiple frequency tones corresponding to the x and y positions of columns and rows, which are independently changed as a function of time for steering around the AOD-trapped atoms dynamically; the full x and y waveforms are calculated by adding together the time-domain profile of all frequency components with a given amplitude and phase for each component. For running quantum circuits, the positions of the AOD atoms at each gate location are programmed and then smoothly interpolate (with a cubic profile) the AOD frequencies as a function of time between gate positions. The cubic profile enacts a constant jerk onto the atoms, which allows movement of roughly 5-10× faster (without heating and loss) than if moving at a constant velocity (linear profile). In the movement protocol, stretches, compressions, and translations of the AOD trap array are applied: i.e., the AOD rows and columns never cross each other in order to avoid atom loss and heating associated with two frequency components crossing each other.

The AOD tweezer intensity is homogenized throughout the whole atom trajectory in order to minimize dephasing induced by a time-varying magnitude of differential light shifts. To this end, a reference camera is used in the image plane to gauge the intensity of each AOD tweezer at each gate location and homogenize by varying the amplitude of each frequency component; during motion between two locations the amplitude of each individual frequency component is interpolated.

The SLM tweezer light (830 nm) and the AOD tweezer light (828 nm) are generated by two separate, free-running Ti:sapphire lasers (M Squared, 18-W pump). Projected through a 0.5 NA objective, the SLM tweezers have a waist of roughly ~900 nm (~1000 nm for AODs). When loading the atoms, the trap depths are ~2π×16 MHz, with radial trap frequencies of ~2π×80 kHz, and when running quantum circuits the trap depths are ~2π×4 MHz, with radial trap frequencies of ~2π×40 kHz.

### Raman Laser System

Fast, high-fidelity single-qubit manipulations are critical ingredients of the quantum circuits demonstrated in this work. To this end, a high-power 795-nm Raman laser system is used for driving global single-qubit rotations between m_{F}=0 clock states. This Raman laser system is based on dispersive optics. 795-nm light (Toptica TA pro, 1.8 W) is phase-modulated by an electro-optic modulator (Qubig), which is driven by microwaves at 3.4 GHz (Stanford Research Systems SRS SG384) that are doubled to 6.8 GHz and amplified. The laser phase modulation is converted to amplitude modulation for driving Raman transitions through use of a Chirped Bragg Grating (Optigrate). IQ control of the SG384 is used for frequency and phase control of the microwaves, which are imprinted onto the laser amplitude modulation and thus give us direct frequency and phase control over the hyperfine qubit drive.

The Raman laser illuminates the atom plane from the side in a circularly polarized elliptical beam with waists of 40 μm and 560 μm on the thin axis and the tall axis, respectively, with a total average optical power of 150 mW on the atoms. The large vertical extent ensures <1% inhomogeneity across the atoms, and shot-to-shot fluctuations in the laser intensity are also <1%. The Raman laser is operated at a blue-detuned intermediate-state detuning of 180 GHz, resulting in two-photon Rabi frequencies of 1 MHz and an estimated scattering error per π̅ pulse of 7×10⁻⁵ (i.e. 1 scattering event per 15000 π pulses).

### Qubit Coherence and Dynamical Decoupling

In the 830-nm traps, hyperfine qubit coherence is characterized by

$${T}_{2}^{*} = 4 ms$$

(not plotted here), T₂=1.5s (XY16 with 128 total π pulses), and T₁=4 s (including atom loss). The experiments described herein are performed in a DC magnetic field of 8.5 Gauss. Coherence can be further improved by using further-detuned optical tweezers (with trap depth held constant, the tweezer differential lightshifts decrease as 1/Δ and 1/T₁ decreases as 1/Δ³) and shielding against magnetic field fluctuations. For practical QEC operation, atom loss can be detected in a hardware-efficient manner and the atom then replaced from a reservoir, which could in principle be continuously reloaded by a MOT for reaching arbitrarily deep circuits.

The transport sequences are accompanied with dynamical decoupling sequences. The number of pulses used is a tradeoff between preserving qubit coherence while minimizing pulse errors. In various embodiments, there is an interchange between two types of dynamical decoupling sequences: XY8/XY16 sequences, composed of phase-alternated individual π-pulses which are self-correcting for amplitude and detuning errors, and CPMG-type dynamical decoupling sequences composed of robust BB1 pulses. The CPMG-BB1 sequence is more robust to amplitude errors but incurs more scattering error. The sequence may be empirically optimized for any given experiment by choosing between these different sequences and a variable number of decoupling π pulses, optimizing on either single-qubit coherence (including the movement) or the final signal. Typically, decoupling sequences are composed of a total 12-18× pulses.

### Movement Effects on Atom Heating and Loss

The following discusses the effects of movement on atom loss and heating in the harmonic oscillator potential given by the tweezer trap. Motion of the trap potential is equivalent to the non-inertial frame of reference where the harmonic oscillator potential is stationary, but the atom experiences a fictitious force given by F(t)=−m a(t), where m is the mass of the particle and a(t) is the acceleration of the trap as a function of time. The average vibrational quantum number increase ΔN is given by

$$Δ N = \frac{{\vert \tilde{a} ( {ω}_{0} ) \vert}^{2}}{{( 2 {x}_{zpf} {ω}_{0} )}^{2}} \qquad Equation 10$$

where ã(w₀) is the Fourier transform of a(t) evaluated at the trap frequency ω₀, and the zero point size of the particle x_{zpf}≡\sqrt{ℏ/(2mω₀)}. ΔN is the same for all initial levels of the oscillator. Experimentally, an acceleration profile a(t)=jt is applied to the atom, from time −T/2 to +T/2 to move a distance D with constant jerk j. Calculating |á(ω)|², simplify using ω₀T>>1, and assume a small range of trap frequencies to average the oscillatory terms, results in

$$Δ N = \frac{1}{2} {( \frac{\frac{6 D}{{x}_{spf}}}{{ω}_{0}^{2} {T}^{2}} )}^{2} \qquad Equation 11$$

Several relevant insights can be gleaned from this formula. First, this expression indicates the ability to move large distances D with comparably small increases in time T. Furthermore, to maintain a constant ΔN, the movement time T∝ω₀^{-3/4}. Moreover, to perform a large number of moves k for a deep circuit, ΔN∝k/T⁴ can be estimated, suggesting that the number of moves can be increased from, e.g., 5 to 80 by slowing each move from 200 μs to 400 μs. Move speed could be further improved with different a(t) profiles, but inevitably with finite resources such as trap depth, quantum speed limits will eventually prevent arbitrarily fast motion of qubits across the array.

Equation 11 is now compared to experimental observations. Atom loss is observed with movement of 55 μm in 200 μs under a constant negative jerk. This speed limit is consistent with the above estimates: using ω₀=2π×40 kHz and x_{zpf}=38 nm, it is predicted that ΔN≈6 for this move, corresponding to the onset of tangible heating at this move speed. More quantitatively, a Poisson distribution is assumed with mean N and variance N and integrate the population above some critical Nₘₐₓ upon which the atom will leave the trap. From this analysis, atom retention is given by

$$\frac{1}{2} ( 1 + erf [ \frac{{N}_{max} - N}{\sqrt{2 N}} ] ) .$$

Additional heating and loss during the circuit can also be caused by repeated short drops for performing two-qubit gates, where the tweezers are briefly turned off to avoid anti-trapping of the Rydberg state and light shifts of the ground-Rydberg transition. However, drop-recapture measurements suggest the 500-ns drops used experimentally have a negligible effect until hundreds of drops per atom (corresponding to hundreds of CZ gates). Atom loss and heating as a function of number of drops are well-described by a diffusion model, which would then predict that reducing atom temperature by a factor of 2×(reducing thermal velocity by \sqrt{2}×) and reducing drop time t_{drop} by 2×, together would increase the number of possible CZ gates per atom to thousands.

### Two-Qubit CZ Rates Implementation

Two-qubit gates and calibrations may be implemented using the techniques provided herein. Specifically, the two-qubit CZ gate is implemented by two global Rydberg pulses, with each pulse at detuning Δ and length τ, and with a phase jump ξ between the two pulses. The pulse parameters are chosen such that qubit pairs, adjacent and under the Rydberg blockade constraint, will return from the Rydberg state back to the hyperfine qubit manifold with a phase depending on the state of the other qubit. The numerical values for these pulse parameters are:

$$Δ = - 0.377371 Ω$$

$$ξ = - 0.621089 \times ( 2 π )$$

$$τ = 0.683201 / [ Ω / ( 2 π ) ]$$

Exemplary experiments are operated with a two-photon Rydberg Rabi frequency of Ω/2π=3.6 MHz, giving a theoretical τ=190 ns and a theoretical Δ/(2π)=−1.36 MHz. The negative detuning sign is chosen to help minimize excitation into the mⱼ=+1/2 Rydberg state which is detuned by about 24 MHz under the field of 8.5 G (and experiences a 3×lower coupling to the Rydberg laser than the desired mⱼ=−1/2 state due to reduced Clebsch-Gordan coefficients). In this work strong blockade between adjacent qubits is provided, with Rydberg-Rydberg interactions V₀/2π ranging from 200 MHz to 1 GHz.

### Managing Spurious Phases During CZ Rates

The two-qubit gate induces both an intrinsic single-qubit phase, as well as spurious phases which are primarily induced by the differential light shift from the 420-nm laser. Under certain configurations, the 420-nm-induced differential light shift on the hyperfine qubit can be exceedingly large (>8 MHz), yielding phase accumulations on the hyperfine qubit of ≈6π. Small, percent-level variations of the 420-nm intensity can thus lead to significant qubit dephasing.

This 420-induced-phase issue may be addressed by performing an echo sequence: after the CZ gate, the 1013-nm Rydberg laser is turned off, a Raman π pulse is applied, and then the 420-nm laser is pulsed again to cancel the phase induced by the 420 light during the CZ gate. This method echoes out the 420-induced phase, but comes at a cost of a factor of two increase in the 420-induced scattering error, which is the dominant source of error in two-qubit CZ gates.

Echo between CZ gates. To address these various issues, a Raman π pulse is performed between each CZ gate to echo out spurious gate-induced phases on the hyperfine qubit. This approach has several advantages. The 420-induced phase is now cancelled by pairs of CZ gates, without explicitly applying additional 420-nm pulses to echo each individual CZ gate, thereby reducing the scattering error of the CZ gate in this work by a factor of approximately two. This echo technique, having reduced the scattering error incurred during each gate, roughly compensates the increased scattering rate incurred by spreading optical power over more space in 2D, thereby giving comparable gate fidelities to the two-qubit CZ gate fidelities of ≥97.4(2)%. Further, the echo between CZ gates also cancels the intrinsic single-qubit phase of the CZ gate, removing errors in the calibration of this parameter, as well as canceling any other gate-induced spurious single-qubit phases such as a s 0.01 rad phase induced by pulsing the traps off for 500 ns for the two-qubit gate. In instances where the number of CZ gates is odd, the echo for the final CZ gate is performed.

Sign of intermediate-state detuning. To further suppress the effect of the spurious, 420-induced phase, the 420-nm laser is operated to be red-detuned (by 2 GHz) from the 6P_{3/2} transition. For red detunings, the light shift on the |0 [symbol] state and the |1 [symbol] state are of the same sign, minimizing the differential light shift, while for blue detunings <6.8 GHz, the light shift on the |0 [symbol] state and the |1 [symbol] state have opposite signs and amplify the differential light shift.

### Sensitivity to Axial Trap Oscillations

In typical Rydberg excitation timescales with optical tweezers, the axial trap oscillation frequencies of several kHz are inconsequential. Here, with circuits running as long as 1.2 ms, with Rydberg pulses throughout, the axial trap oscillations can have important effects. In particular, the axial oscillations cause the atoms to make oscillations in/out of the Rydberg beams: at estimated axial temperature of ~25 μK and axial oscillation frequency of 6 kHz, an axial spread \sqrt{ [symbol]z² [symbol]}≈1.3 μm is estimated. For 20-micron-waist beams, the effect of [symbol] this positional spread is relatively small on the pulse parameters of the CZ gate, but can be significant on the sensitive 420-induced phase that should be canceled by echoing out the phase induced by CZ gates separated by ~200 μs. When using 20-micron-waist beams, and a 2.5-GHz blue detuning of the 420-nm laser, the dephasing due to the axial trap oscillations is significant. To remedy this deleterious effect, the beam waist of the 420-nm laser is increased to 35 microns (while maintaining constant intensity) and the laser frequency is changed to be 2-GHz red-detuned, together resulting in a significant reduction in the dephasing associated with improper echoing of the 420-nm pulse.

### Rydberg Beam Shaping and Homogeneity

The Rydberg beams are shaped into tophats of variable size through wavefront control using the phase profile on a spatial light modulator (SLM). This ability allows matching the height of the beam profile to the experiment zone size of any given experiment, thereby maximizing the 1013-nm light intensity and CZ gate fidelities. The Rydberg beam homogeneity is optimized until peak-to-peak inhomogenities are below <1%. To this end, all aberrations are corrected up to the window of the vacuum chamber, which yields an inhomogeneity on the atoms of several percent that is attributed to imperfections of the final window. To further optimize the homogeneity, aberration corrections are tuned on the tophat through Zernike polynomial corrections to the phase profile in the SLM plane (Fourier plane). With this procedure peak-to-peak inhomogeneities are reduced to <1% over a range of 40-50 μm in the atom plane.

### Coherent Mapping Protocol

A coherent mapping protocol is provided to transfer a generic many-body state in the {|1 [symbol] , |r [symbol] }basis to the long-lived and non-interacting {|0 [symbol] , |1 [symbol] } basis. To achieve this mapping, immediately following the Rydberg dynamics, a Raman π pulse is applied to map |1 [symbol] →|0 [symbol] , and then a subsequent Rydberg π-pulse to map |r [symbol] →|1 [symbol] .

Even for perfect Raman and Rydberg π pulses (on isolated atoms), there are three key sources of infidelity associated with this mapping process:
(1) Any population in blockade-violating states (i.e., two adjacent atoms both in |r [symbol] ) will be strongly shifted off-resonance for the final Rydberg π pulse. As such, this atomic population will be left in the Rydberg state and lost.
(2) Long-range interactions, e.g., from next-nearest-neighbors, will detune the final Rydberg π pulse from resonance and thus reduce pulse fidelity. Since the long-range interactions are not the same for all many-body microstates, this effect cannot be mitigated by a simple shift of the detuning.
(3) Dephasing of the state occurs throughout the duration of the Raman π pulse, predominantly from Doppler shifts between the ground states |0 [symbol] , |1 [symbol] and the Rydberg state |r [symbol] . Although these random on-site detunings are also present during the many-body dynamics, turning the Rydberg drive Ω off allows the system to freely accumulate phase and makes us particularly sensitive to dephasing errors.

The above error mechanisms are mitigated as follows. To minimize errors from (1), many-body dynamics are performed with

$$\frac{{Ω}^{2}}{2 {V}_{0}^{2}} \approx 0.01 .$$

This minimizes the probability of an atom to violate blockade to be of order 1%. To help minimize errors from (2), the amplitude of the 420-nm laser is increased for the final π pulse by a factor of 2×, such that

$${( \frac{{V}_{NNN}}{Ω} )}^{2} = 0.005$$

(where V_{NNN} are the interactions with next-nearest neighbors), reducing pulse errors from long-range interactions to order 1%. Finally, to reduce errors from (3), a fast Raman π pulse is performed, leaving only 150 ns between ending the many-body Rydberg dynamics and beginning the Rydberg π pulse. The 150-ns gap is comparably short relative to the

$${T}_{2}^{*} \approx 3 - 4 μ s$$

of the {|g [symbol] , |r [symbol] } basis, leading to a random phase accumulation of order ~0.02×2π rad per particle, but is further compounded by having entangled states of N particles in one copy accumulating a random phase relative to entangled states of N particles in the second copy.

The global Raman beam induces a light-shift-induced phase shift of ≈π on |0 [symbol] , |1 [symbol] relative to |r [symbol] during the Raman π pulse. Similarly, the global 420-nm laser also induces a light-shift-induced phase shift of ≈n between |0 [symbol] and |1 [symbol] during the Rydberg z pulse. While the measurements performed here are interferometric (in other words, the singlet state measured is invariant under global rotations) and thus not affected by these global phase shifts, these phase shifts can be measured and accounted for where relevant.

### Formation of Array of Particles Using Optical Tweezers

Optical trapping of neutral atoms is a powerful technique for isolating atoms in vacuum. Atoms are polarizable, and the oscillating electric field of a light beam induces an oscillating electric dipole moment in the atom. The associated energy shift in an atom from the induced dipole, averaged over a light oscillation period, is called the AC Stark shift. Based on the AC Stark shift induced by light that is detuned (i.e., offset in wavelength) from atomic resonance transitions, atoms are trapped at local intensity maxima (for red detuned, that is, longer wavelength trap light), because the atoms are attracted to light below the resonance frequency. The AC Stark shift is proportional to the intensity of the light. Thus, the shape of the intensity field is the shape of an associated atom trap. Optical tweezers utilize this principle by focusing a laser to a micron-scale waist, where individual atoms are trapped at the focus. Two-dimensional (2D) arrays of optical tweezers are generated by, for example, illuminating a spatial light modulator (SLM), which imprints a computer-generated hologram on the wavefront of the laser field. The 2D array of optical tweezers is overlapped with a cloud of laser-cooled atoms in a magneto-optical trap (MOT). The tightly focused optical tweezers operate in a “collisional blockade” regime, in which single atoms are loaded from the MOT, while pairs of atoms are ejected due to light-assisted collisions, ensuring that the tweezers are loaded with at most single atoms, but the loading is probabilistic, such that the trap is loaded with a single atom with a probability of about 50-60%.

To prepare deterministic atom arrays, a real-time feedback procedure identifies the randomly loaded atoms and rearranges them into pre-programmed geometries. Atom rearrangement requires moving atoms in tweezers which can be smoothly steered to minimize heating, by using, for example, acousto-optic deflectors (AODs) to deflect a laser beam by a tunable angle which is controlled by the frequency of an acoustic waveform applied to the AOD crystal. Dynamic tuning of the acoustic frequency translates into smooth motion of an optical tweezer. A multi-frequency acoustic wave creates an array of laser deflections, which, after focusing through a microscope objective, forms an array of optical tweezers with tunable position and amplitude that are both controlled by the acoustic waveform. Atoms are rearranged by using an additional set of dynamically moving tweezers that are overlaid on top of the SLM tweezer array.

### Exempla Hardware

Optical tweezer arrays constitute a powerful and flexible way to construct large scale systems composed of individual particles. Each optical tweezer traps a single particle, including, but not limited to, individual neutral atoms and molecules for applications in quantum technology. Loading individual particles into such tweezer arrays is a stochastic process, where each tweezer in the system is filled with a single particle with a finite probability p<1, for example p~0.5 in the case of many neutral atom tweezer implementations. To compensate for this random loading, real-time feedback may be obtained by measuring which tweezers are loaded and then sorting the loaded particles into a programmable geometry. This may be performed by moving one particle at a time, or in parallel.

Parallel sorting may be achieved by using two acousto-optic deflectors (AODs) to generate multiple tweezers that can pick up particles from an existing particle-trapping structure, move them simultaneously, and release them somewhere else. This can include moving particles around within a single trapping structure (e.g., tweezer array) or transporting and sorting particles from one trapping system to another (e.g., between one tweezer array and another type of optical/magnetic trap). This sorting is flexible and allows programmed positioning of each particle. Each movable trap is formed by the AODs and its position is dynamically controlled by the frequency components of the radiofrequency (RF) drive field for the AODs. Since the RF drive of the AODs can be controlled in real time and can include any combination of frequency components, it is possible to generate any grid of traps (such as a line of arbitrarily positioned traps), move the rows or columns of the grid, and add or remove rows and columns of the grid, by changing the number, magnitude, and distribution of the frequency components in the RF drive fields of the AODs.

In an exemplary embodiment, an optical tweezer array is created using a liquid crystal on silicon spatial light modulator (SLM), which can programmatically create flexible arrangements of tweezers. These tweezers are fixed in space for a given experimental sequence and loaded stochastically with individual atoms, such that each tweezer is loaded with probability p~0.5. A fluorescence image of the loaded atoms is taken, to identify in real-time which tweezers are loaded and which are empty.

After detecting which tweezers are loaded, movable tweezers overlapping the optical tweezer array can dynamically reposition atoms from their starting locations to fill a target arrangement of traps with near-unity filling. The movable tweezers are created with a pair of crossed AODs. These AODs can be used to create a single moveable trap which moves one atom at a time to fill the target arrangement or to move many atoms in parallel.

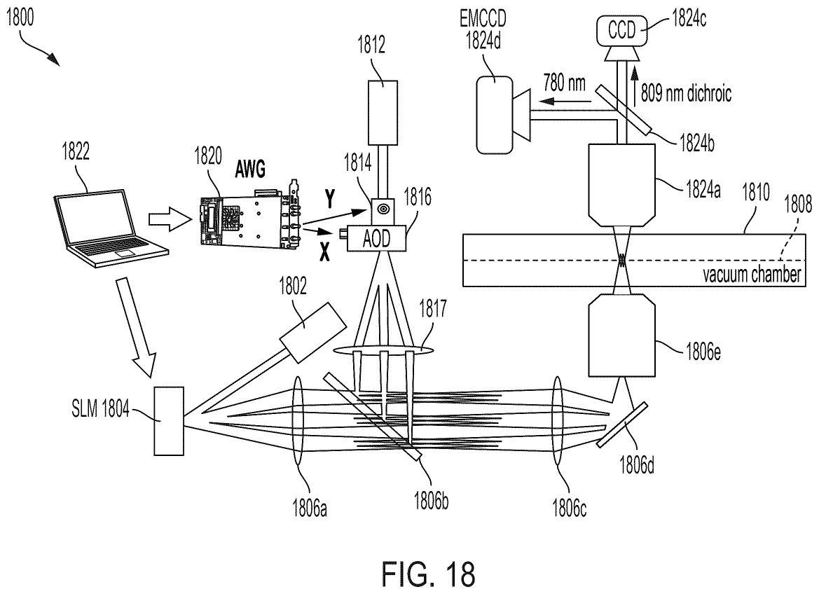

Referring to FIG. 18, a schematic view is provided of an apparatus 1800 for quantum computation according to embodiments of the present disclosure. As shown in FIG. 18, using a beam generated by a light source 1802 (for example, a coherent light source, in some example embodiments—a monochromatic light source), SLM 1804 forms an array of trapping beams (i.e., a tweezer array) which is imaged onto trapping plane 1808 in vacuum chamber 1810 by an optical train that, in the example embodiment shown in FIG. 18, comprises elements 1806a, 1806c, 1806d, and a high numerical aperture (NA) objective 1806e. Other suitable optical trains can be employed, as would be easily recognized by a person of ordinary skill in the art. Using a beam generated by light source 1812 (for example, a coherent light source; in some example embodiments—a monochromatic light source), a pair of AODs 1814 and 1816, having non-parallel directions of acoustic wave propagation (for example, orthogonal directions) creates dynamically movable sorting beams.

By using the optical train, such as the one depicted in FIG. 18 (elements 1817, 1806b, 1806c, 1806d, and 1806e), the sorting beams are overlapped with the trapping beams. It is understood that other optical train can be used to achieve the same result. For example, source 1802 and 1812 can be a single source, and the trapping beam and the sorting beam are generated by a beam splitter.

The dynamic movement of the steering beams is accomplished by employing two non-parallel AODs 1814, 1816, arranged in series. In the example embodiment depicted in FIG. 18, one AOD defines the direction of “rows” (“horizontal”—the ‘X’ AOD) and the other AOD defines the direction of “columns” (“vertical”—the ‘Y’ AOD). Each AOD is driven with an arbitrary RF waveform from an arbitrary waveform generator 1820, which is generated in real-time by a computer 1822 which processes the feedback routine after analyzing the image of where atoms are loaded. If each AOD is driven with a single frequency component, then a single steering beam (“AOD trap”) is created in the same plane 1808 as the SLM trap array. The frequency of the X AOD drive determines the horizontal position of the AOD trap, and the frequency of the Y AOD drive determines the vertical position; in this way, a single AOD trap can be steered to overlap with any SLM trap.

In FIG. 18, laser 1802 projects a beam of light onto SLM 1804. SLM 1804 can be controlled by computer 1822 in order to generate a pattern of beams (“trapping beams” or “tweezer array”). The pattern of beams is focused by lens 1806a, passes through mirror 1806b, and is collimates by lens 1806c on mirror 1806d. The reflected light passes through objective 1806e to focus an optical tweezer array in vacuum chamber 1810 on trapping plane 1808. The laser light of the optical tweezer array continues through objective 1824a, and passes through dichroic mirror 1824b to be detected by charge-coupled device (CCD) camera 1824c.

Vacuum chamber 1810 may be illuminated by an additional light source (not pictured). Fluorescence from atoms trapped on the trapping plane also passes through objective 1824a, but is reflected by dichroic mirror 1824b to electron-multiplying CCD (EMCCD) camera 1824d. In this example, laser 1812 directs a beam of light to AODs 1814, 1816. AODs 1814, 1816 are driven by arbitrary wave generator (AWG) 1820, which is in turn controlled by computer 1822. Crossed AODs 1814, 1816 emit one or more beams as set forth above, which are directed to focusing lens 1817. The beams then enter the same optical train 1806b . . . 1806e as described above with regard to the optical tweezer array, focusing on trapping plane 1808.

It will be appreciated that alternative optical trains may be employed to produce an optical tweezer array suitable for use as set out herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method of performing quantum error correction, the method comprising:
providing a plurality of data qubits, each of the plurality of data qubits disposed in a corresponding trap;
providing a plurality of ancilla qubits, each of the plurality of ancilla qubits disposed in a corresponding trap;
arranging the plurality of data qubits and the plurality of ancilla qubits in a plurality of rows and a plurality of columns, thereby forming a lattice;
performing a plurality of permutations of the plurality of rows and the plurality of columns, each of the plurality of permutations placing each of the plurality of data qubits within an interaction radius of one of the plurality of ancilla qubits, thereby forming a plurality of proximate pairs;
subsequent to each of the plurality of permutations, applying a global control pulse to the lattice, thereby applying a gate to each of the plurality of proximate pairs, and thereby encoding a parity check matrix between the plurality of ancilla qubits and the plurality of data qubits.

2. The method of claim 1, further comprising, prior to forming the lattice:
applying a control laser pulse to the plurality of data qubits to thereby prepare them in an initial state.

3. The method of claim 1, wherein arranging the plurality of data qubits and the plurality of ancilla qubits in the lattice comprises:
moving, in parallel, the plurality of ancilla qubits into the lattice.

4. The method of claim 1, wherein performing the plurality of permutations comprises:
moving, in parallel, one or more rows within the lattice and moving, in parallel, one or more columns within the lattice.

5. The method of claim 1, wherein the plurality of ancilla qubits comprises Z stabilizers and X stabilizers.

6. The method of claim 1, further comprising:
removing a subset of the plurality of ancilla qubits from the lattice and performing a measurement on the subset.

7. The method of claim 6, wherein the subset corresponds to Z stabilizers.

8. The method of claim 6, wherein the subset corresponds to X stabilizers.

9. The method of claim 1, wherein performing the plurality of permutations comprises:
determining a collision-free path for each of the plurality of data qubits and each of the plurality of ancilla qubits for each of the plurality of permutations.

10. The method of claim 9, wherein determining the collision-free path comprises:
bipartition and recursive sorting of the plurality of data qubits and the plurality of ancilla qubits.

11. The method of claim 9, wherein the collision-free path is a cubic spline.

12. The method of claim 9, wherein determining the collision-free path comprises:
decomposing the parity check matrix into a first product graph and a second product graph;
determining a routing of the plurality of rows according to the first product graph;
determining a routing of the plurality of columns according to the second product graph.

13. The method of claim 12, wherein the plurality of permutations comprises row-specific and/or column-specific permutations.

14. The method of claim 13, wherein performing the plurality of permutations comprises:
applying a pinning beam to at least one qubit of the plurality of data qubits or the plurality of ancilla qubits, thereby maintaining the position of the at least one qubit according to the routing of the plurality of rows or columns.

15-18. (canceled)

19. The method of claim 1, wherein the parity check matrix implements a Lifted Product (LP) code.

20. The method of claim 19, further comprising:
prior to performing the plurality of permutations, flattening the LP code.

21. The method of claim 20, wherein flattening the LP code comprises iteratively dividing and flattening the LP code.

22. The method of claim 1, wherein the gate applied to each of the plurality of proximate pairs is a CZ gate.

23. (canceled)

24. The method of claim 1, wherein the trap corresponding to each of the plurality of data qubits and to each of the plurality of ancilla qubits is an optical trap.

25. The method of claim 24, wherein
the optical traps corresponding to the plurality of data qubits and to the plurality of ancilla qubits are generated by directing a beam of light to at least one acousto-optic deflector (AOD), and
moving the one or more rows and moving the one or more columns comprises varying a drive frequency of the at least one AOD.

26-28. (canceled)
